(19) United States
(12) Patent Application Publication
(10) Pub. No.: US 2017/0255893 A1
(43) Pub. Date: Sep. 7, 2017

(54) INFORMATION PROCESSING APPARATUS AND CORRELATION DISPLAY METHOD

(71) Applicant: FUJITSU LIMITED, Kawasaki-shi (JP)

(72) Inventors: Hiroyuki Murai, Sumida (JP); Hiroki Kunimura, Ota (JP)

(73) Assignee: FUJITSU LIMITED, Kawasaki-shi (JP)

(21) Appl. No.: 15/425,114

(22) Filed: Feb. 6, 2017

(30) Foreign Application Priority Data
Mar. 3, 2016 (JP) 2016-040711

(51) Int. Cl. G06Q 10/06; G06Q 10/10

(52) U.S. Cl. CPC G06Q 10/063112; G06Q 10/1053

(57) ABSTRACT

An information processing apparatus includes a storage unit and a computing unit. The computing unit accepts a registration of trust relationship information indicating a trust relationship between specified users among a plurality of registered users, and stores the trust relationship information in the storage unit. When receiving an instruction to display a relationship between a first user and a second user, the computing unit displays a correlation diagram of trust relationships in a range of trust relationships linked between the first user and the second user, and information indicating a trust relationship registered for trust to the second user, irrespective of the range, in parallel to each other.

### CROSS-REFERENCE TO RELATED APPLICATION

This application is based upon and claims the benefit of priority of the prior Japanese Patent Application No. 2016-040711, filed on Mar. 3, 2016, the entire contents of which are incorporated herein by reference.

### FIELD

The embodiments discussed herein relate to an information processing apparatus and a correlation display method.

### BACKGROUND

Many techniques using correlation diagrams representing correlations among people have been considered. For example, there has been proposed a technique in which a shared information management terminal displays a network having the name of a person in charge arranged in the center and the names of people concerned arranged around the person in charge. In addition, there has been proposed a technique in which an information processing apparatus displays a correlation diagram visualizing changes of correlations among a certain reference person and people who have relationships with the reference person with time. Furthermore, there has been proposed a technique in which a server displays a personal network diagram based on the degrees of relationships between registered people.

Please see, for example, Japanese Laid-open Patent Publication Nos. 2007-052557, 2013-3635, and 2006-244524.

By the way, a relationship between a certain person and another person may be used for evaluating the trustworthiness of the certain person. For example, when a user decides whether to invite a specific user to a business-related event, such as a workshop, the user may use relationships between the specific user and other users. However, there is a problem of how to extract other users who have relationships with the specific user, in order to extract useful information for making the decision.

### SUMMARY

According to one aspect, there is provided an information processing apparatus that includes: a memory; and a processor configured to perform a process including accepting a registration of information indicating a trust relationship between specified users among a plurality of users who are registered, storing the information in the memory, and displaying, upon receiving an instruction to display a relationship between a first user and a second user among the plurality of users, a correlation diagram of trust relationships in a range of trust relationships linked between the first user and the second user, and information indicating a trust relationship registered for trust to the second user, irrespective of the range, in parallel to each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an information processing system according to a second embodiment;

FIG. 3 illustrates an example of hardware of a management server;

FIG. 4 illustrates an example of functions of the management server;

FIG. 5 illustrates an example of a user table;

FIG. 6 illustrates an example of a workshop object table;

FIG. 7 illustrates an example of a workshop participation table;

FIG. 8 illustrates an example of a workshop invitation table;

FIG. 9 illustrates an example of a recommendation table;

FIG. 10 illustrates an example of a user information registration screen;

FIG. 11 is a flowchart illustrating an example of a user information registration process;

FIG. 12 illustrates an example of a user information screen and workshop information registration screen;

FIG. 13 is a flowchart illustrating an example of a workshop information registration process;

FIG. 14 illustrates an example of a user search screen;

FIG. 15 illustrates an example of a user search result screen;

FIG. 16 is a flowchart illustrating an example of a user search process;

FIG. 17 illustrates an example of a workshop invitation screen;

FIG. 18 is a flowchart illustrating an example of a workshop invitation process;

FIG. 19 illustrates an example of a workshop list screen and application screen;

FIG. 20 is a flowchart illustrating an example of an application process;

FIG. 21 illustrates an example of a user information screen;

FIG. 22 is a flowchart illustrating an example of a process of allowing participation of an applicant;

FIG. 23 illustrates an example of a user recommendation screen;

FIG. 24 is a flowchart illustrating an example of a recommendation reason registration process;

FIG. 25 illustrates an example of a potential invitee information screen;

FIG. 26 is a flowchart illustrating an example of a process of displaying a potential invitee information screen;

FIG. 27 is a diagram illustrating an example of a recommendation screen; and

FIG. 28 is a flowchart illustrating an example of a process of displaying a recommendation screen.

### DESCRIPTION OF EMBODIMENTS

Several embodiments will be described below with reference to the accompanying drawings, wherein like reference numerals refer to like elements throughout.

### First Embodiment

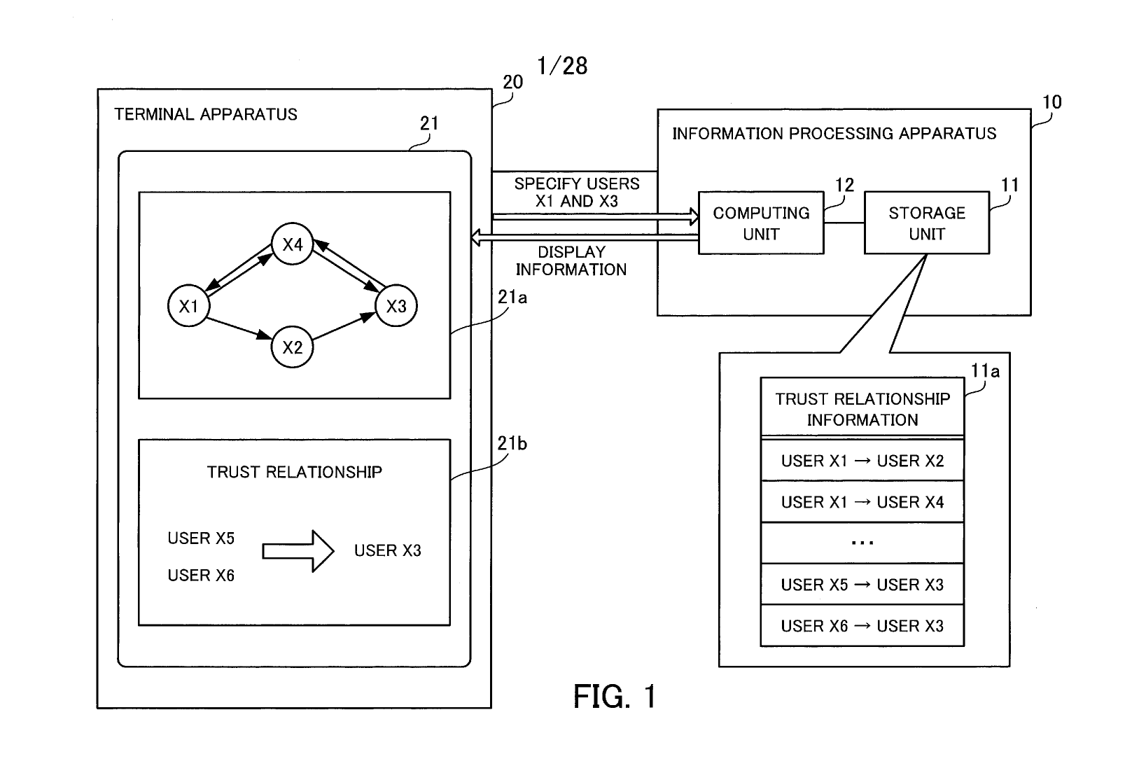

FIG. 1 illustrates an information processing apparatus according to a first embodiment. An information processing apparatus 10 is able to provide information that indicates trust relationships between users among a plurality of users and is usable for making a decision on what kind of person a user is. FIG. 1 illustrates an example where a terminal apparatus 20 operated by an operator is connected to the information processing apparatus 10, and a display device, not illustrated, is connected to the terminal apparatus 20. The terminal apparatus 20 is able to display images on the display device on the basis of display information received from the information processing apparatus 10. In the following explanation, a user who uses the terminal apparatus 20 is referred to as a user X1.

The information processing apparatus 10 includes a storage unit 11 and a computing unit 12. The storage unit 11 may be a volatile storage device, such as a Random Access Memory (RAM), or a non-volatile storage device, such as a Hard Disk Drive (HDD) or a flash memory. The computing unit 12 is a processor, for example. The processor may be a Central Processing Unit (CPU), a Digital Signal Processor (DSP), an Application Specific Integrated Circuit (ASIC), a Field Programmable Gate Array), or another. The computing unit 12 may be a multiprocessor.

The storage unit 11 stores information indicating trust relationships of one or more users among a plurality of users. Referring to the example of FIG. 1, the storage unit 11 stores trust relationship information 11a including such information. A trust relationship indicates that a user trusts another user. For example, information indicating a pair of trusting and trusted users is registered in the trust relationship information 11a. In the example of FIG. 1, a trust relationship indicating that the user X1 trusts a user X2 is registered as such information. Furthermore, as such a trust relationship, a pair of recommending and recommended users may be registered in terms of capability or personality.

The computing unit 12 accepts a registration of information indicating a trust relationship between specified users from the terminal apparatus 20 or another device, not illustrated. For example, the computing unit 12 accepts a registration of information indicating that the user X1 trusts another user. The computing unit 12 registers the received information in the trust relationship information 11a stored in the storage unit 11.

In addition, the computing unit 12 receives an instruction to display a relationship between a first user and a second user, for example, from the terminal apparatus 20. By this instruction, provision of information on the second user is requested. A highly possible case is that the user X1 himself/herself is specified as the first user. As an example of this case, the following describes a case where the user X1 decides whether to invite another user to a business-related event.

There are many events in which various users are desired to participate. For example, users who specialize in different fields from the user X1 are desired. For example, in the case where the user X1 specializes in the fields of hardware, users who specialize in the fields of software may be desired for an event. This is because users who specialize in different fields may come up with ideas from different viewpoints. However, the user X1 may not know any users who specialize in different fields. If the user X1 finds a user trustworthy on the basis of some information even if the user X1 does not know the user, the user X1 may desire to invite the user to the event. Therefore, the user X1 makes a research on the unacquainted user using the terminal apparatus 20. For example, such an unacquainted user is found by a search under conditions set in terms of specialized fields or levels on various kinds of skills. In this example, the unacquainted user is called a user X3. In this case, the users X1 and X3 are specified to the information processing apparatus 10.

When receiving an instruction to display a relationship between the user X1 and the user X3, the computing unit 12 generates a correlation diagram 21a of trust relationships in a range of trust relationships linked between the user X1 and the user X3, and displays the correlation diagram 21a on the terminal apparatus 20. In addition, the computing unit 12 displays information indicating trust relationships registered for trust to the user X3, irrespective of this range, in parallel to the correlation diagram 21a. As a result, the terminal apparatus 20 displays a screen 21 where the correlation diagram 21a and an area 21b including the information indicating the trust relationships registered for the trust to the user X3 are arranged in parallel to each other, on the display device.

In the example of FIG. 1, the correlation diagram 21a indicates that there are trust relationships from the user X1 to the users X2 and X4, from the users X2 and X4 to the user X3, and from the user X3 to the user X4. On the other hand, the area 21b displays information indicating the trust relationships registered for the trust to the user X3 in the storage unit 11, irrespective of whether users are included in the correlation diagram 21a or not. In the example of FIG. 1, information indicating that the users X5 and X6, who are not included in the correlation diagram 21a, trust the user X3 is registered in the trust relationship information 11a. Therefore, the computing unit 12 displays information indicating that at least the users X5 and X6 trust the user X3, in the area 21b.

The user X1 is able to estimate the trustworthiness of the user X3 by checking the correlation diagram 21a. In the example of FIG. 1, the users X2 and X4 that the user X1 trusts trust the user X3. Therefore, the user X1 is able to determine that the user X3 is trustworthy to some extent. In addition, in the correlation diagram 21a, more links existing on a route from the user X1 to the user X3 means that the trustworthiness of the user X3 from the viewpoint of the user X1 decreases.

However, the correlation diagram 21a indicates only users included in the range of trust relationships linked between the user X1 and the user X3. Therefore, only limited information for making a determination on the trustworthiness of the user X3 may be obtained. For example, there is a possibility that information indicating how a user who the user X1 does not know evaluates the user X3 may be unavailable.

To deal with this, in the area 21b, information indicating the users X5 and X6 who are registered in the trust relationship information 11a as users trusting the user X3 and are not included in the correlation diagram 21a is displayed. This enables the user X1 to confirm that not only the users X2 and X4, which the user X1 himself/herself trusts, but also the users X5 and X6 trust the user X3. In this case, for example, since the user X1 knows that more users trust the user X3, the user X1 finds the user X3 more trustworthy. In addition, the user X1 is able to appropriately determine the trustworthiness of the user X3, depending on what kind of people the users displayed in the area 21b are. For example, depending on whether the user X1 knows the user X5, X6, and, if the user X1 knows the user X5, X6, what kind of person the user X5, X6 is, the user X1 is able to determine the trustworthiness of the user X3.

As described above, the area 21b is displayed together with the correlation diagram 21a. This means that the information processing apparatus 10 provides useful information for determining the trustworthiness of the user X3. Thereby, the user X1 is able to easily determine the trustworthiness of the user X3. For example, the user X1 is able to appropriately decide whether to invite the user X3 to the above event on the basis of the determined trustworthiness.

### Second Embodiment

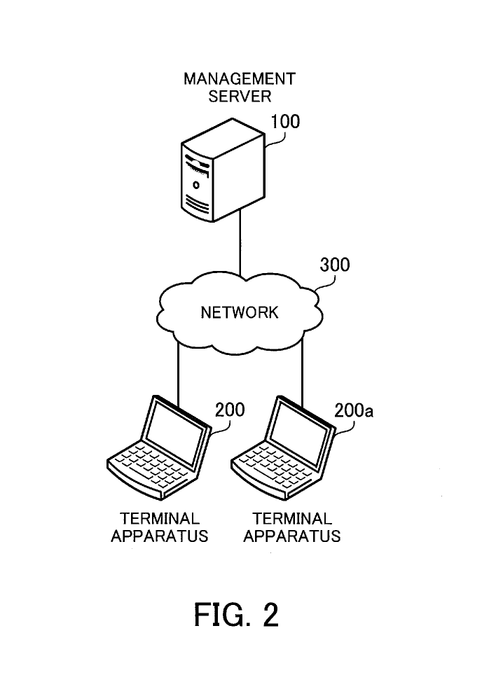

FIG. 2 illustrates an information processing system according to a second embodiment. An information processing system includes a management server 100 and terminal apparatuses 200 and 200a. In the information processing system, various workshop-related processes are performed. For example, in the information processing system, a procedure to hold a workshop, a procedure to participate in a workshop, a procedure to invite someone to a workshop, and others are performed. The management server 100 and the terminal apparatuses 200 and 200a are connected to each other over a network 300. The network 300 may be a Local Area Network (LAN), a Wide-Area Network (WAN), the Internet, or another.

The management server 100 is a computer that manages workshop-related information. In response to requests from the terminal apparatuses 200 and 200a, the management server 100 provides the terminal apparatuses 200 and 200a with workshop-related information.

The terminal apparatuses 200 and 200a are computers that are used by users registered in the management server 100. The terminal apparatuses 200 and 200a display workshop-related information received from the management server 100 on their own displays. The users use the terminal apparatuses 200 and 200a for user registration in the management server 100, for holding workshops, for participating in workshops, for inviting other users to workshops, for searching for other users to invite, for browsing information about other users, and others.

The following describes hardware of the management server 100.

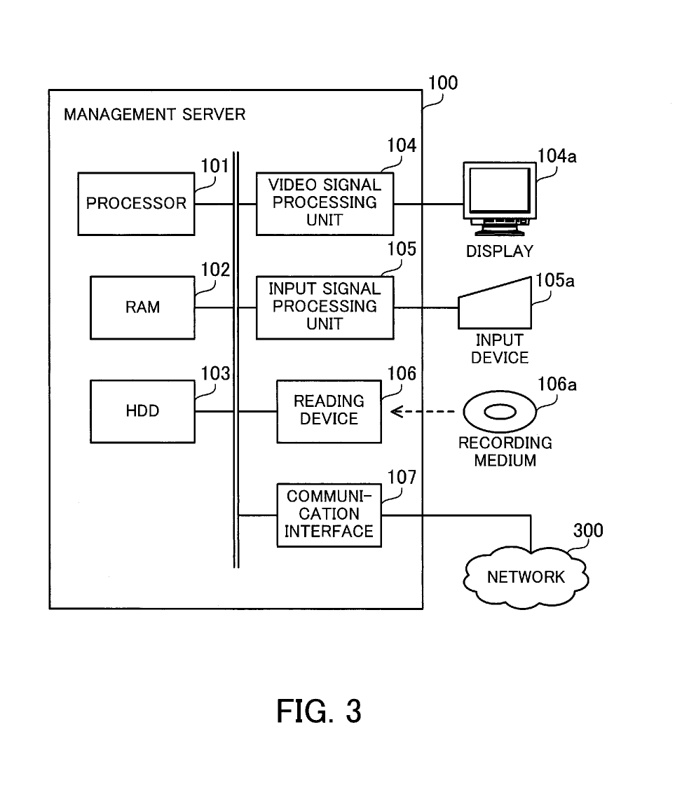

FIG. 3 illustrates an example of hardware of a management server. The management server 100 includes a processor 101, a RAM 102, an HDD 103, a video signal processing unit 104, an input signal processing unit 105, a reading device 106, and a communication interface 107. These units are connected to a bus within the management server 100.

The processor 101 controls the whole of the management server 100. The processor 101 may be a multiprocessor including a plurality of processing elements. The processor 101 may be, for example, a CPU, a DSP, an ASIC, an FPGA, or another. The processor 101 may be a combination of two or more elements selected from a CPU, a DSP, an ASIC, an FPGA, and others.

The RAM 102 is a main storage device of the management server 100. The RAM 102 temporarily stores at least part of Operating System (OS) programs and application programs to be run by the processor 101 and a variety of data that is used while the processor 101 operates.

The HDD 103 is an auxiliary storage device of the management server 100. The HDD 103 magnetically writes and reads data on a built-in magnetic disk. The HDD 103 stores the OS programs, application programs, and a variety of data. The management server 100 may be provided with another kind of auxiliary storage device, such as a Solid State Drive (SSD), or a plurality of auxiliary storage devices.

The video signal processing unit 104 outputs images to a display 104a connected to the management server 100 in accordance with instructions from the processor 101. As the display 104a, a Liquid Crystal Display (LCD), an organic Electro-Luminescence (EL) display, or anther display may be used.

The input signal processing unit 105 receives input signals from an input device 105a connected to the management server 100, and outputs the input signals to the processor 101. As the input device 105a, a pointing device, such as a mouse or touch panel, a keyboard, or another input device may be used. A plurality of input devices may be connected to the management server 100.

The reading device 106 reads programs and data from a recording medium 106a. For example, as the recording medium 106a, a magnetic disk, such as a Flexible Disk (FD) or an HDD, an optical disc, such as a Compact Disc (CD) or a Digital Versatile Disc (DVD), or a Magneto-Optical disk (MO) may be used. In addition, as the recording medium 106a, a flash memory card or another non-volatile semiconductor memory may be used, for example. The reading device 106 stores programs and data read from the recording medium 106a in the RAM 102 or HDD 103, in accordance with instructions from the processor 101, for example.

The communication interface 107 communicates with the terminal apparatuses 200 and 200a over a network 300.

In this connection, the terminal apparatuses 200 and 200a may be configured with the same hardware as the management server 100.

The following describes the functions of the management server 100.

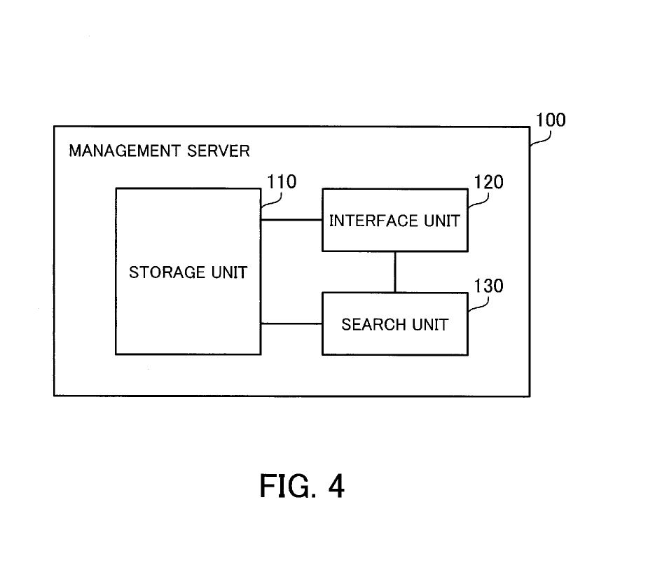

FIG. 4 illustrates an example of functions of the management server. The management server 100 includes a storage unit 110, an interface unit 120, and a search unit 130.

The storage unit 110 is implemented as a storage area set aside in the RAM 102 or HDD 103, for example. The storage unit 110 stores therein a user table, a workshop object table, a workshop participation table, a workshop invitation table, and a recommendation table.

The user table contains user information. The workshop object table contains workshop-related information. The workshop participation table contains information regarding participation in a workshop. The workshop invitation table contains information regarding an invitation to a workshop. The recommendation table contains reasons for recommendation.

At least part of the interface unit 120 and search unit 130 is implemented by the processor 101 executing prescribed programs, for example.

The interface unit 120 provides a Graphical User Interface (GUI) for the terminal apparatuses 200 and 200a. More specifically, the interface unit 120 creates HyperText Markup Language (HTML) files for displaying GUI screens. The interface unit 120 sends the created HTML files to the terminal apparatuses 200 and 200a, which then display the GUI screens based on the HTML files on their Web browsers. The interface unit 120 receives processing requests via the GUI screens and executes requested processes. For example, the interface unit 120 registers information in the storage unit 110 and retrieves information from the storage unit 110. In addition, the interface unit 120 may request the search unit 130 to search for user information. The interface unit 120 sends a processing result to a requesting source, which then displays the processing result on its GUI screen.

The search unit 130 performs a user search when the interface unit 120 receives a user search instruction from the terminal apparatus 200 or 200a.

The following describes information stored in the storage unit 110 in detail.

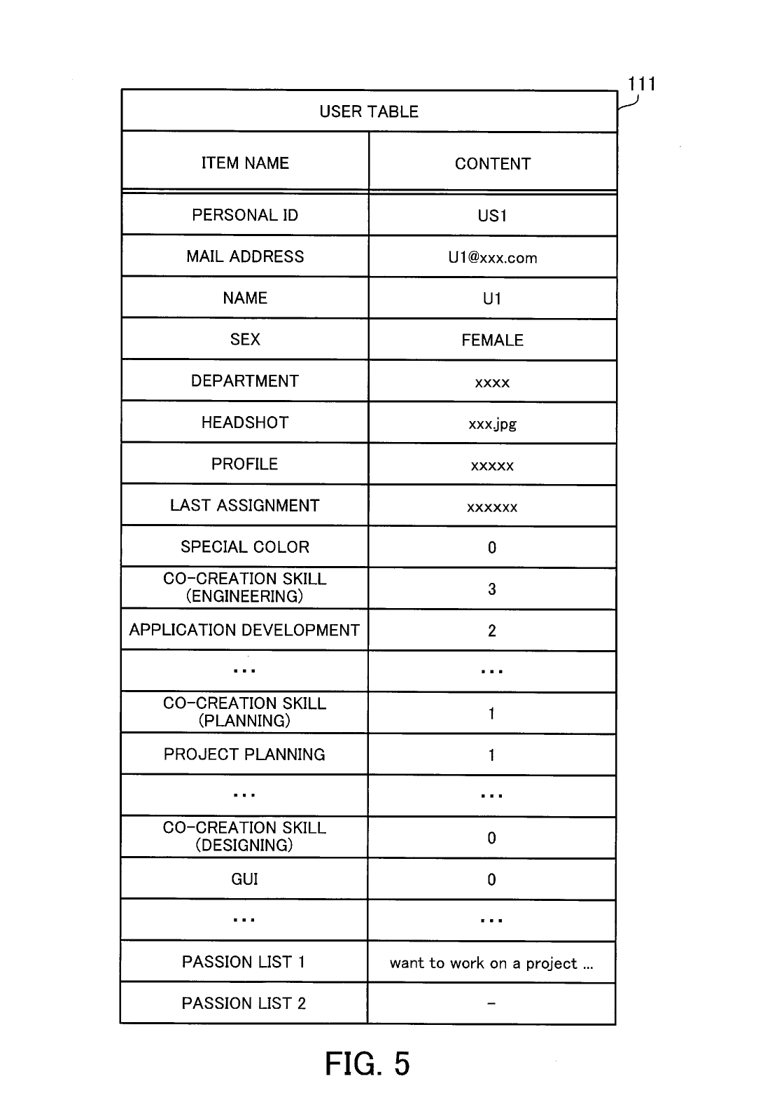

FIG. 5 illustrates an example of a user table. A user table 111 is created for each user and is registered in the storage unit 110.

The user table 111 includes the following fields: Item Name and Content. For example, the Item Name field includes the following items: Personal Identifier (ID) of a user, Mail Address of the user; Name of the user; Sex of the user; Department indicating the department to which the user belongs; Headshot indicating the file name of a headshot of the user; Profile of the user; and Last Assignment of the user. The Content field contains information corresponding to each item name.

The Item Name field further includes Special Color as an item. A special color is a color representing user personality and characteristics based on the personality (for example, what kind of role a user is good at). The Content field corresponding to the Special Color contains a number identifying a color.

The Item Name field further includes information regarding skills called “Co-creation Skill”. The Co-creation Skill is classified into three skill items: Engineering, Planning, and Designing. In the user table 111, a level is registered for each skill item. In addition, each skill item of the Co-creation Skill is subdivided into a plurality of job types. Although the subdivisions are not all illustrated in FIG. 5, for example, the Engineering skill is divided into Application Development, Infrastructure Construction, and Hardware Designing. The Planning skill is divided into Project Planning, Marketing, and Intellectual Property. The Designing skill is divided into GUI, Graphics, Product, and Movie. The user table 111 contains a skill level for each job type.

The Item Name field further includes Passion List 1 and 2. The Passion List 1 and 2 contain user's desires or interests in the form of text, for example.

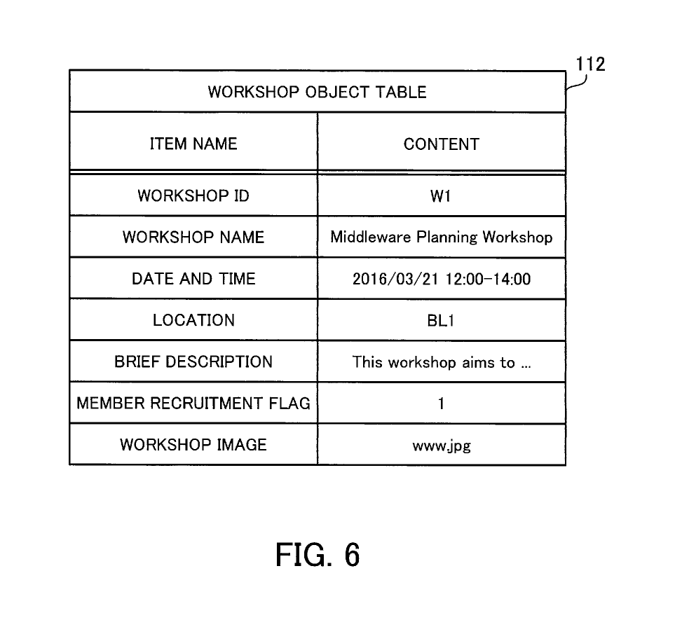

FIG. 6 illustrates an example of a workshop object table. A workshop object table 112 is created for each workshop and is stored in the storage unit 110.

The workshop object table 112 includes the following fields: Item Name and Content. The Item Name field includes the following items: Workshop ID identifying a workshop, Workshop Name indicating the name of the workshop, Date and Time of the workshop, Location of the workshop, Brief Description describing the details of the workshop, Member Recruitment Flag, and Workshop Image. The Content field contains information corresponding to each item name. The Member Recruitment Flag indicates whether to recruit members for the workshop. In the Content field for the Member Recruitment Flag, either “1” indicating that the workshop accepts applicants or “0” indicating that the workshop does not accept applicants is registered. In the Content field for the Workshop Image, the file name of an image to be displayed in a screen for the workshop is registered.

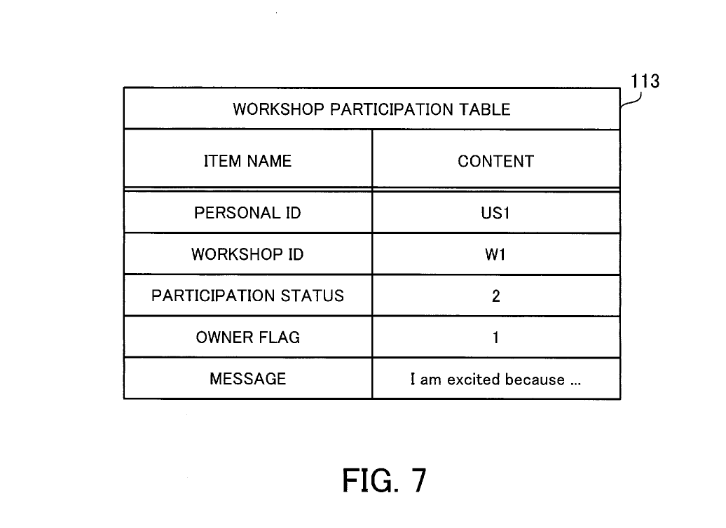

FIG. 7 illustrates an example of a workshop participation table. A workshop participation table 113 is created for each user who participates in one workshop and is registered in the storage unit 110.

The workshop participation table 113 includes the following fields: Item Name and Content. The Item Name field includes the following items: Personal ID identifying a user, Workshop ID identifying a workshop, Participation Status, Owner Flag, Message, and others. The Content field contains information corresponding to each item name.

The Participation Status indicates whether a user has been offered an invitation to a workshop, has applied for participation in the workshop, or is going to participate in the workshop. In the Content field for the Participation Status, any one of “O” indicating “having been offered an invitation”, “1” indicating “having applied for participation”, and “2” indicating “going to participate” is registered. The Owner Flag indicates whether the user is the owner (organizer) of a workshop or not. In the Content field for the Owner Flag, either “1” indicating “an owner” or “0” indicating “a participating member” is registered. In the Content field for the Message, a message to be displayed on the screen of the workshop is registered in the form of text.

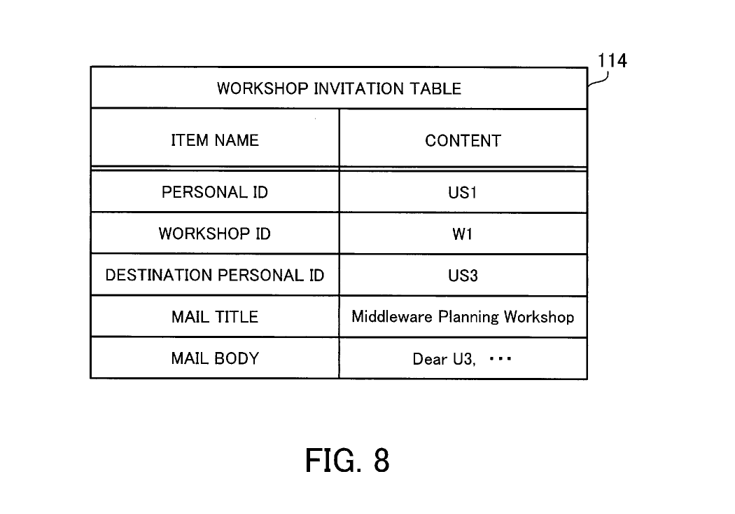

FIG. 8 illustrates an example of a workshop invitation table. A workshop invitation table 114 is created to indicate information about an email created by the owner of a workshop to invite a user to the workshop, and is registered in the storage unit 110.

The workshop invitation table 114 includes the following fields: Item Name and Content. The Item Name field includes the following items: Personal ID identifying a sender user, Workshop ID identifying a workshop, Destination Personal ID identifying a receiver user, Mail Title, and Mail Body. The Content field contains information corresponding to each item name.

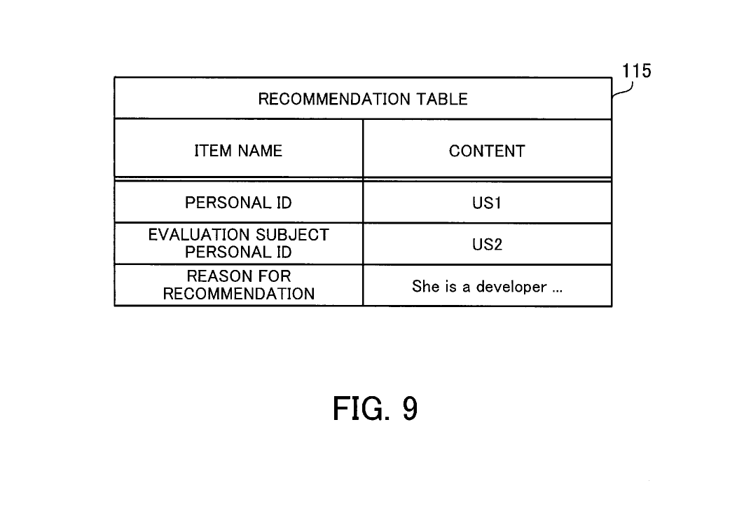

FIG. 9 illustrates an example of a recommendation table. A recommendation table 115 is created by a user using a Recommend button (to be described later) to recommend another user, and is registered in the storage unit 110.

The recommendation table 115 includes the following fields: Item Name and Content. The Item Name field includes the following items: Personal ID identifying a recommending user, Evaluation Subject Personal ID identifying a user to be recommended (evaluation subject), and Reason for Recommendation. The Content field contains information corresponding to each item name. In the Content field for the Reason for Recommendation, reasons why the evaluation subject is recommended are registered in the form of text.

The following describes a process of registering user information in the management server 100.

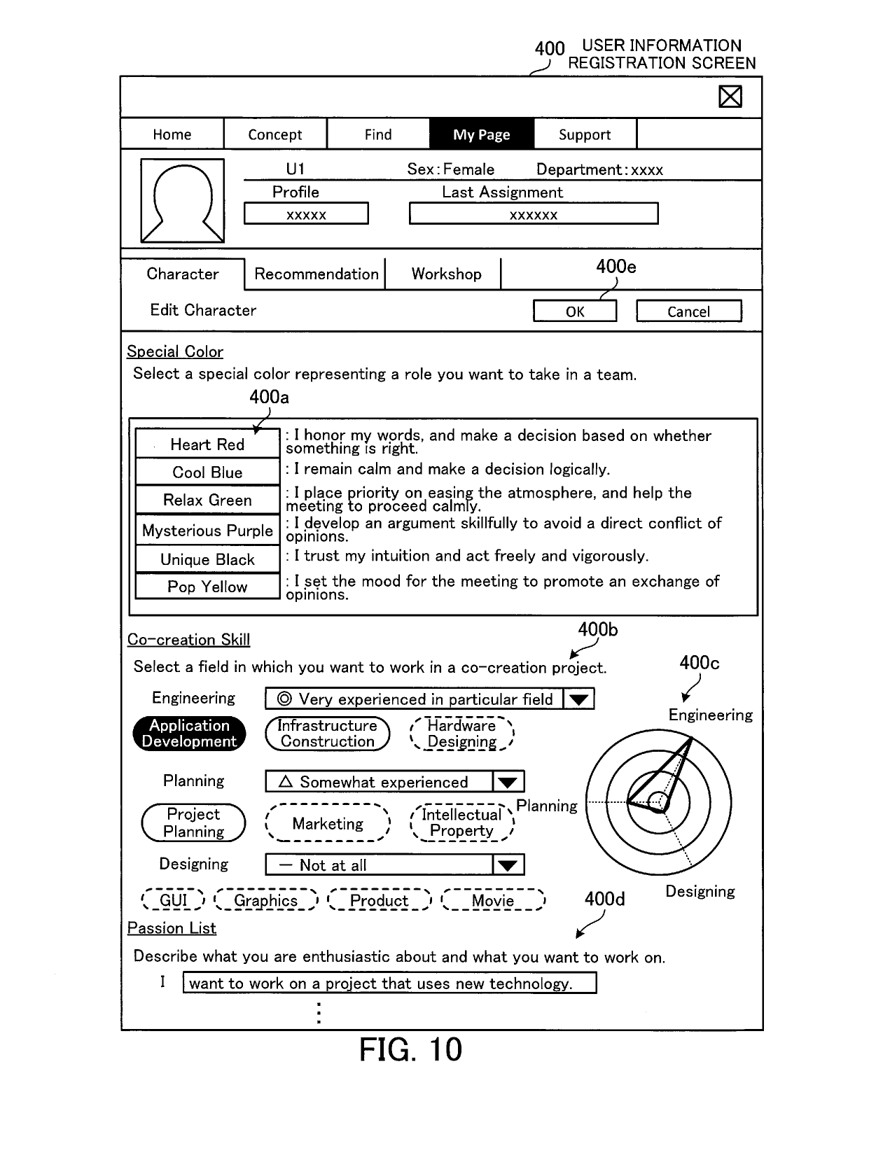

FIG. 10 illustrates an example of a user information registration screen. A user information registration screen 400 is a GUI for registering user information. The user information registration screen 400 is used for registering a profile, a special color, a co-creation skill, a passion list, and others.

For example, the user information registration screen 400 includes a button area 400a where buttons for selecting a special color are provided. When any of the buttons in the button area 400a is pressed, the corresponding special color is registered. As described earlier, a special color is a color representing user personality and characteristics based on the personality. For example, “Heart Red” indicates red, “Cool Blue” indicates blue, “Relax Green” indicates green, “Mysterious Purple” indicates purple, “Unique Black” indicates black, and “Pop Yellow” indicates yellow.

In addition, the user information registration screen 400 includes a setting area 400b for skill items. The setting area 400b is used to set a level among a plurality of predetermined levels for each of the skill items: Engineering, Planning, and Designing. When a level is set for a skill item, the skill level is reflected on a radar chart 400c. In the radar chart 400c, a vertex corresponding to a set level is plotted on an axis for each skill item, and the vertices are connected with straight lines. This enables the user to intuitively recognize a balance of levels set for the skill items.

In addition, the setting area 400b for the skill items is used to set a skill level for each job type. For example, referring to FIG. 10, the highest level is set for application development, the second highest level is set for infrastructure construction, and the lowest level is set for hardware designing.

In addition, a passion list setting area 400d is used to enter text describing user's desires or interests. In this connection, in the setting area 400d, a plurality of pieces of such information may be entered.

When an OK button 400e is pressed after such setting is complete, the entered user information is sent to the management server 100 for requesting a registration of the user information.

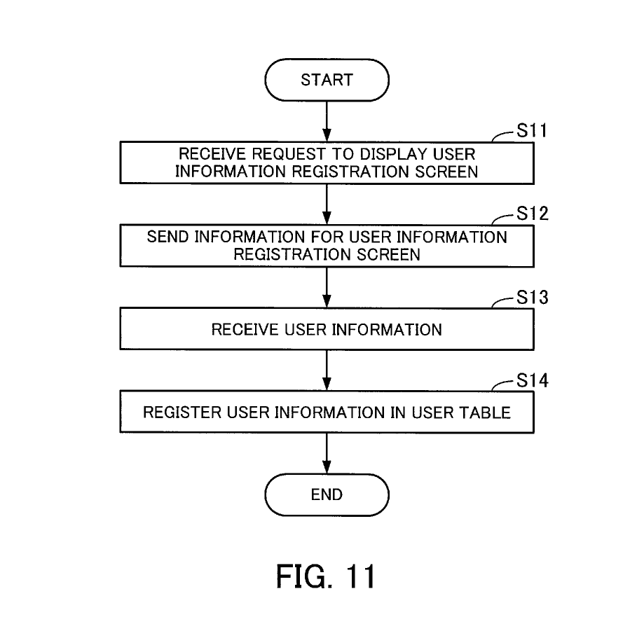

FIG. 11 is a flowchart illustrating an example of a user information registration process. Hereinafter, the process of FIG. 11 will be described step by step.

(S11) The interface unit 120 receives a request to display the user information registration screen 400 from the terminal apparatus 200.

(S12) The interface unit 120 creates an HTML file for displaying the user information registration screen 400 on the terminal apparatus 200. The interface unit 120 sends the created HTML file to the terminal apparatus 200 to display the user information registration screen 400 on the Web browser of the terminal apparatus 200. Thereby, the user information registration screen 400 is displayed on the terminal apparatus 200.

After that, the user of the terminal apparatus 200 enters user information in the user information registration screen 400. Now, the user of the terminal apparatus 200 is called a user U1. When the setting of the user information is complete, the user U1 presses the OK button 400e on the user information registration screen 400. When the OK button 400e is pressed, the terminal apparatus 200 sends the user information to the management server 100 for requesting a registration of the user information.

(S13) The interface unit 120 receives the user information from the terminal apparatus 200.

(S14) The interface unit 120 creates a user table 111 corresponding to the user U1, and registers the received user information in the created user table 111. The interface unit 120 registers the user table 111 containing the user information in the storage unit 110. Then, the process is completed.

The following describes a process of registering information about a workshop to be held, in the management server 100 for the user U1 to hold the workshop.

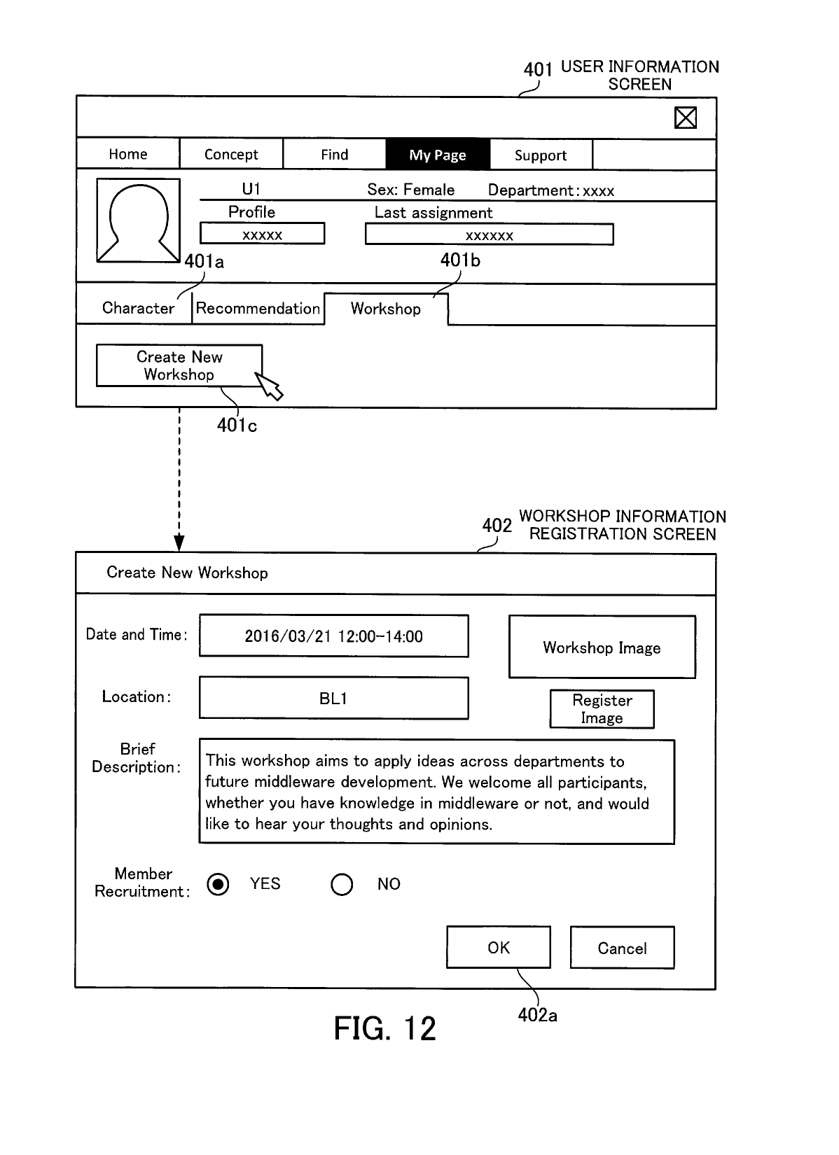

FIG. 12 illustrates an example of a user information screen and workshop information registration screen. A user information screen 401 is a GUI for displaying user information. When a Character tab 401a is pressed, the user information screen 401 displays the details of registered user information. In addition, when a Workshop tab 401b is pressed, a Create New Workshop button 401c for creating a new workshop is displayed as illustrated in FIG. 12.

When the Create New Workshop button 401c is pressed, a workshop information registration screen 402 is displayed. The workshop information registration screen 402 includes fields for setting workshop information indicating when and where a workshop is to be held, and others. When an OK button 402a is pressed, the entered workshop information is sent to the management server 100 for requesting a registration of the workshop information.

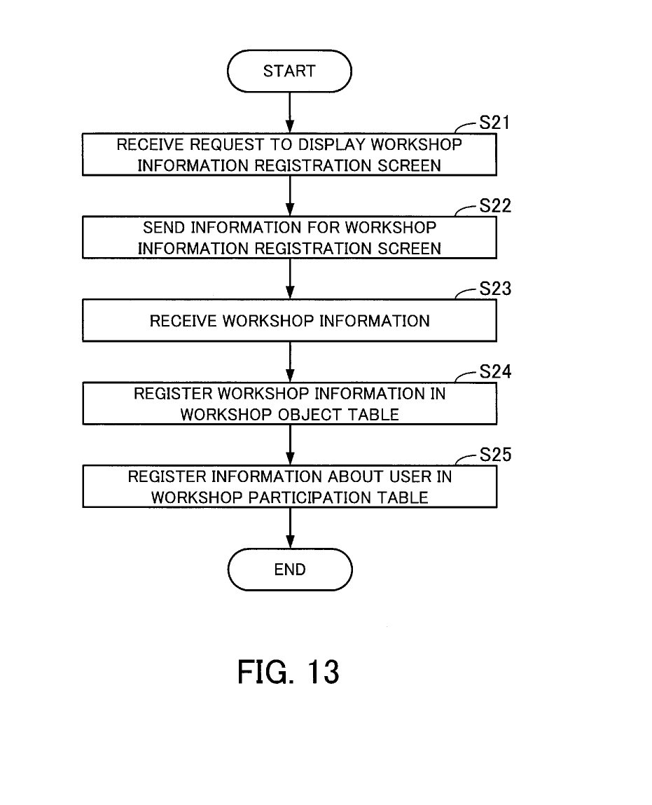

FIG. 13 is a flowchart illustrating an example of a workshop information registration process. The process of FIG. 13 starts when the user U1 presses the Create New Workshop button 401c on the user information screen 401. The process of FIG. 13 will be described step by step.

(S21) The interface unit 120 receives a request to display the workshop information registration screen 402 from the terminal apparatus 200.

(S22) The interface unit 120 creates an HTML file for displaying the workshop information registration screen 402 on the terminal apparatus 200. The interface unit 120 sends the created HTML file to the terminal apparatus 200 to display the workshop information registration screen 402 on the Web browser of the terminal apparatus 200. Thereby, the workshop information registration screen 402 is displayed on the terminal apparatus 200.

The user U1 enters the date and time, location, and others of a workshop on the displayed workshop information registration screen 402. Then, the user U1 presses the OK button 402a on the workshop information registration screen 402 after finishing the entry of such information. When the OK button 402a is pressed, the terminal apparatus 200 sends the workshop information to the management server 100.

(S23) The interface unit 120 receives the workshop information from the terminal apparatus 200.

(S24) The interface unit 120 creates a workshop object table 112, and registers the received workshop information in the created workshop object table 112. The interface unit 120 stores the workshop object table 112 containing the workshop information in the storage unit 110.

(S25) The interface unit 120 creates a workshop participation table 113 having the ID “UI” of the user U1 as the personal ID. In the created workshop participation table 113, the interface unit 120 registers the ID of the newly created workshop as the Workshop ID, registers “2” indicating “going to participate” as the Participation Status, and registers “1” indicating “an owner” as the Owner Flag. In addition, the interface unit 120 registers text information entered as the Brief Description in the workshop information registration screen 402, as the Message. The interface unit 120 stores the workshop participation table 113 containing the above information in the storage unit 110.

With the above process, information indicating that a new workshop is to be held by the user U1 as an owner is registered in the management server 100.

The following describes a user search process. For example, the user search process is performed by the management server 100 when the user U1 who is a workshop owner searches for members who the user U1 will want to participate in the workshop.

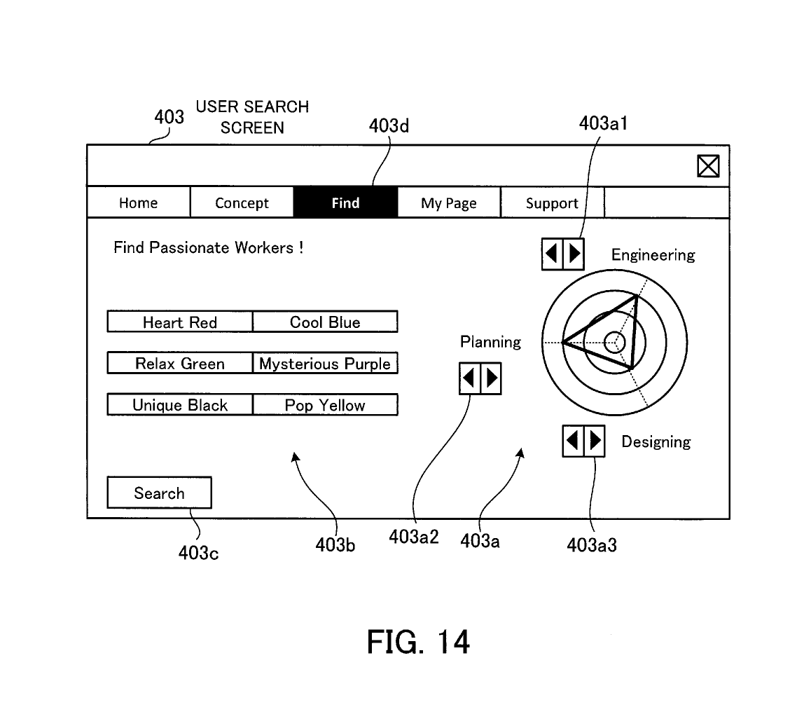

FIG. 14 illustrates an example of a user search screen. A user search screen 403 is a GUI for setting search conditions.

The user search screen 403 displays a radar chart 403a for setting levels for skill items as search conditions. The axes of the radar chart 403a correspond to the skill items: Engineering, Planning, and Designing. The position of a vertex on each axis indicates the level of a skill item. The user search screen 403 includes setting buttons 403a1 to 403a3 respectively corresponding to the axes of the radar chart 403a. By pressing the setting buttons 403a1 to 403a3, the user U1 is able to change the positions of the vertices on the corresponding axes. Thereby, the levels are set for the corresponding skill items.

With the above-described method, the user is able to intuitively recognize the levels of the skill items to be set as search conditions and their balance from the shape of the radar chart 403a, compared with the case of setting numerical values as levels for the skill items using a keyboard or the like. In addition, this method reduces the user workload, compared with an operation of entering numerical values using a keyboard or the like.

In this connection, to change the positions of vertices on the axes of the radar chart 403a, a method of directly moving the positions of the vertices by dragging a mouse may be employed, other than the above method.

In addition, the user is able to specify a special color as a search condition, in addition to the levels for the skill items. The user search screen 403 includes a color specification area 403b for specifying a special color. The color specification area 403b includes an area corresponding to each special color, and when an area is pressed, the corresponding special color is specified. A plurality of special colors may be specified.

In addition, the user search screen 403 includes a Search button 403c. When the Search button 403c is pressed, search conditions are fixed. That is, values set in the radar chart 403a and color specification area 403b at this time are sent to the management server 100 as search conditions. Thereby, a search under the search conditions is requested.

Although not illustrated, certain keywords may be entered in the form of text as search conditions. For example, the entered keywords may be used for searching the information of the passion lists registered in the user tables 111.

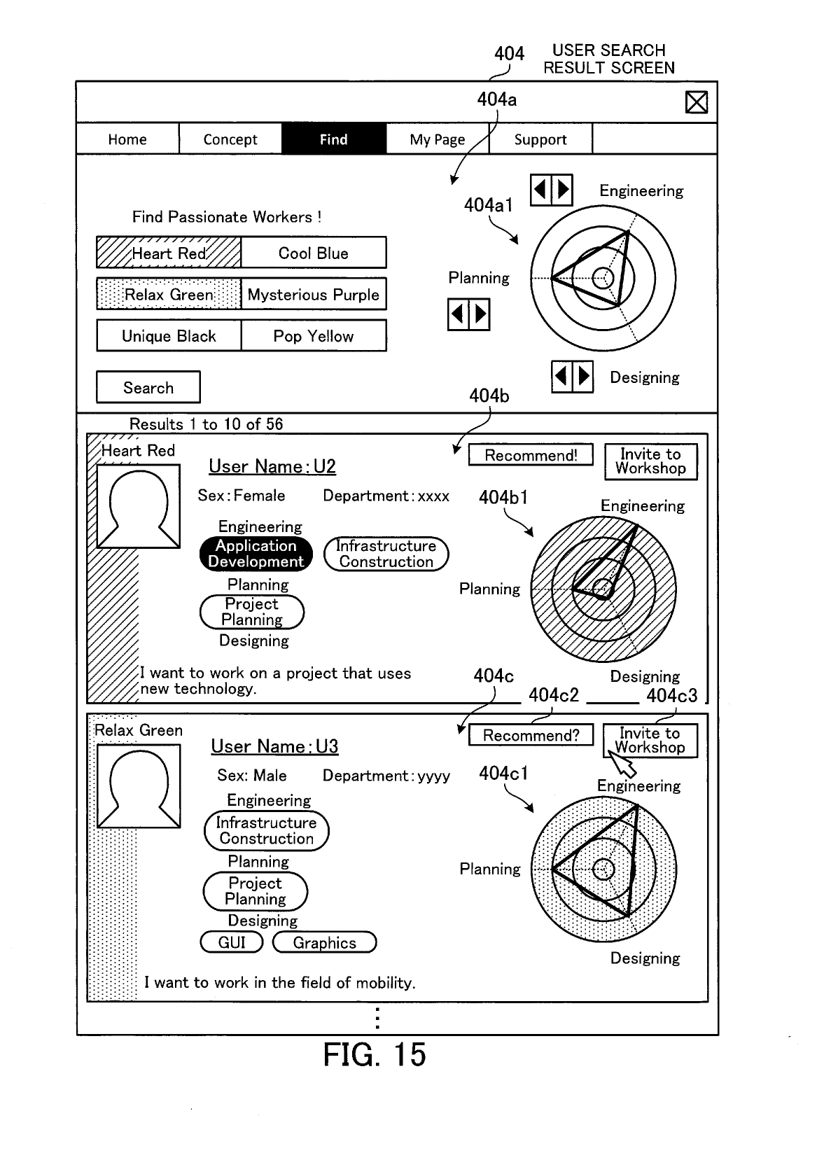

FIG. 15 illustrates an example of a user search result screen. A user search result screen 404 is a GUI for displaying search results.

The user search result screen 404 displays information indicating search conditions and search results. For example, the upper part of the user search result screen 404 includes a search condition area 404a for displaying search conditions. In addition, the lower part of the search condition area 404a includes user areas for displaying information about found users as the search results. Referring to the example of FIG. 15, users U2 and U3 are found by the search, and user areas 404b and 404c corresponding to the users U2 and U3 are displayed.

The search condition area 404a displays a radar chart 404a1 representing levels specified for the skill items as the search conditions. The user area 404b displays a radar chart 404b1 representing levels of the found user U2 for the skill items, and the user area 404c displays a radar chart 404c1 representing levels of the found user U3 for the skill items. These radar charts 404a1, 404b1, and 404c1 have the same axis direction and maximum length for each skill item. This makes it possible to compare the levels for each skill item by comparing the shapes formed by connecting vertices with straight lines in the radar charts 404a1, 404b1, and 404c1. By comparing these shapes, the user U1 is able to intuitively determine the relationship between the levels of the skill items specified as the search conditions and the levels of the skill items with respect to the users obtained as the search results. For example, the user U1 is able to easily determine whether the levels of the found users for the skill items match the search conditions.

In addition, at least part of each user area is colored in a user's special color. Referring to the example of FIG. 15, shaded areas are colored in special colors. Specifically, the left ends of the user areas 404b and 404c and the insides of the radar charts 404b1 and 404c1 are colored as the special colors. By coloring at least part of each user area in a corresponding special color in this way, the user U1 is able to confirm the personalities of the users U2 and U3 displayed as the search results. For example, in the case where the user search result screen 404 displays a plurality of users who have different special colors and have similar skills, the user U1 is able to select members who the user U1 wants to participate in a workshop, taking their personalities into account.

Further, each user area displays a Recommend button and an Invite button. For example, the user area 404c displays a Recommend button 404c2 and an Invite button 404c3. When the user U1 recommends a found user to other users, the user U1 presses the Recommend button. In this connection, if the user U1 has already recommended the user, “Recommend!” is displayed in the area for the Recommend button. If the user U1 has not yet recommended the user, “Recommend?” is displayed. The Recommend button may be pressed only in the latter case. When the user U1 would like to invite a found user to the workshop whose owner is the user U1, the user U1 presses the Invite button.

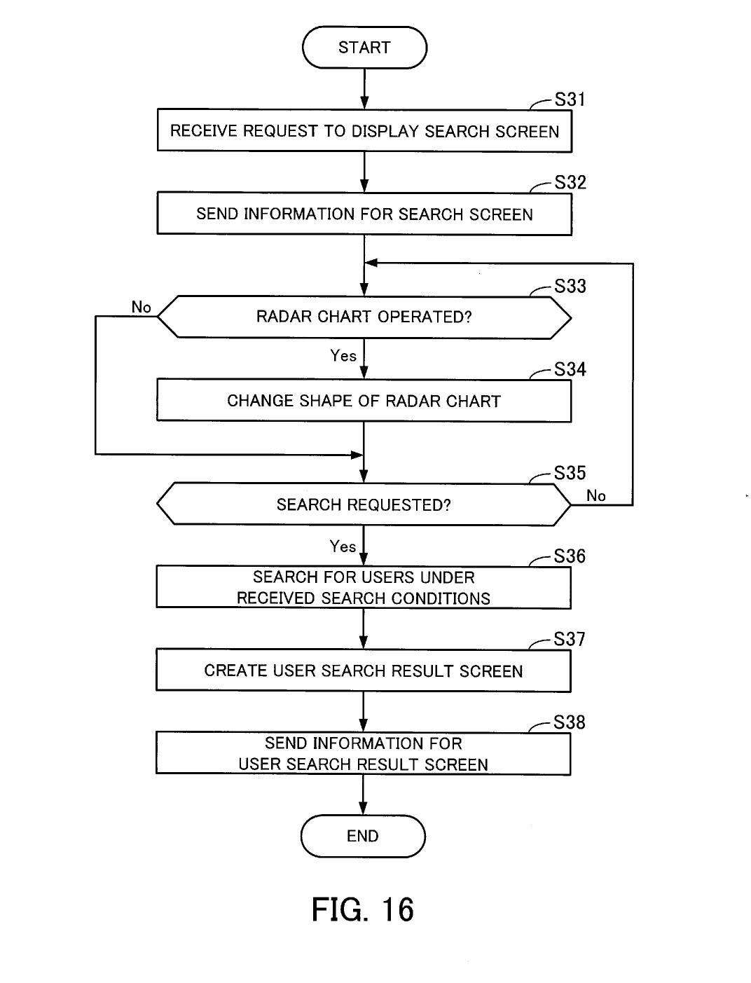

FIG. 16 is a flowchart illustrating an example of a user search process. For example, the process of FIG. 16 starts when the user U1 presses a Find tab 403d (refer to FIG. 14) on the user search screen 403. The process of FIG. 16 will be described step by step.

(S31) The interface unit 120 receives a request to display a user search screen 403 from the terminal apparatus 200.

(S32) The interface unit 120 creates an HTML file for displaying the user search screen 403 on the terminal apparatus 200. The interface unit 120 sends the created HTML file to the terminal apparatus 200 to display the user search screen 403 on the Web browser of the terminal apparatus 200. Thereby, the user search screen 403 is displayed on the terminal apparatus 200.

(S33) The interface unit 120 determines whether an operation to specify levels for the skill items of the radar chart 403a displayed on the user search screen 403 has been performed or not. If the level specification operation is performed, the process proceeds to step S34. If the level specification operation has not been performed, the process proceeds to step S35.

(S34) The interface unit 120 changes the shape of the radar chart 403a displayed on the user search screen 403 according to the level specification operation. More specifically, the interface unit 120 moves the positions of the vertices on the axes and changes the positions of straight lines connecting the vertices in the radar chart 403a, according to the level specification operation.

(S35) The interface unit 120 determines whether a search request has been made by pressing the Search button 403c. If the search request has been made, the process proceeds to step S36. In this case, the interface unit 120 receives the search conditions, as well as the search request. The search conditions include levels for the skill items. In addition, when an operation to specify a special color is performed on the color specification area 403b of the user search screen 403, the search conditions include the identification information of the specified special color as well. If the search request has not been made, the process proceeds to step S33.

In this connection, steps S33 to S35 are repeated at prescribed time intervals.

In addition, steps S33 and S34 are to change the shape of the radar chart 403a according to the level specification operation in the process of the management server 100. However, as an alternative example, the terminal apparatus 200 may be designed to perform the process of changing the shape of the radar chart 403a. For example, at step S32, a program may be sent together with the HTML file for displaying the user search screen 403. Then, the Web browser function of the terminal apparatus 200 may execute this program to thereby change the shape of the radar chart 403a according to the level specification operation.

(S36) The search unit 130 searches the user tables 111 to find users under the search conditions obtained at step S35. For example, the search unit 130 specifies users in decreasing order of the number of items satisfying the search conditions, from the users registered in the user tables ill. An item is considered as satisfying the search conditions when the level of a skill item is greater than a specified level or when a special color is identical to a specified color. Alternatively, the search unit 130 may specify users in order of similarity of a skill or special color to the search conditions, from the users registered in the user tables 111.

(S37) The interface unit 120 creates a user search result screen 404 including the user information of the users found at step S36. The interface unit 120 creates an HTML file for displaying the user search result screen 404 on the terminal apparatus 200. In this connection, this HTML file may be information for additionally displaying only user areas (for example, user areas 404b and 404c of FIG. 15) for the found users or may be information for displaying a search condition area 404a together with the user areas.

(S38) The interface unit 120 sends the created HTML file to the terminal apparatus 200 to display the user search result screen 404 on the Web browser of the terminal apparatus 200. Thereby, the user search result screen 404 is displayed on the terminal apparatus 200. Then, the process is completed.

The following describes the case where the user U1 invites another user U3 to a workshop.

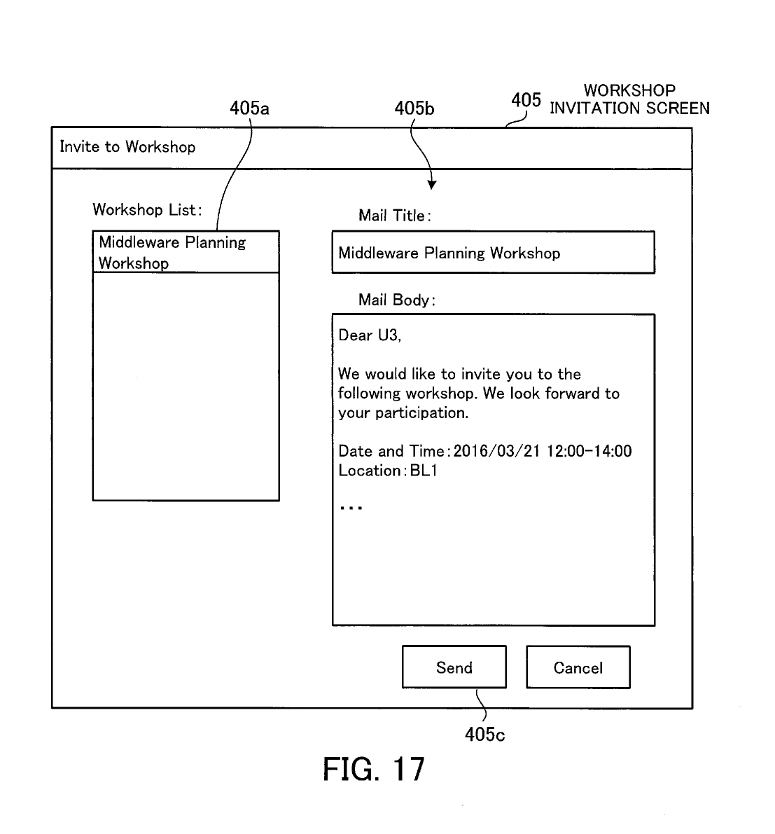

FIG. 17 illustrates an example of a workshop invitation screen. A workshop invitation screen 405 is a GUI for displaying the details for an invitation to a workshop. For example, the workshop invitation screen 405 is displayed on the terminal apparatus 200 when the Invite button 404c3 displayed in the user search result screen 404 is pressed.

The workshop invitation screen 405 displays a list of workshops whose owner is the user U1 in a workshop list display section 405a. In addition, the workshop invitation screen 405 displays a mail entry area 405b for entering an electronic mail to be sent to a user to be invited. When a workshop is selected from the workshop list display section 405a and a Send button 405c is pressed, an electronic mail having the content of a mail title and a mail body entered in the mail entry area 405b is sent to the user U3. Thereby, the user U3 is notified that the user U3 is invited to the selected workshop.

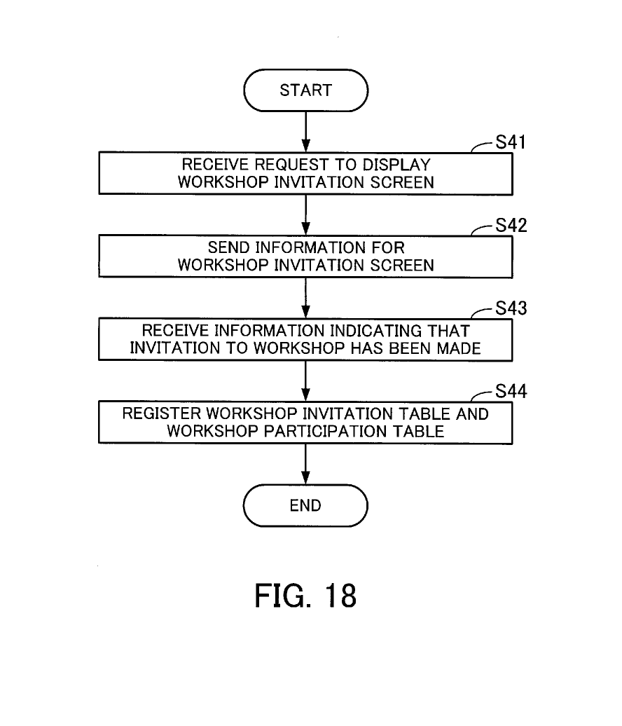

FIG. 18 is a flowchart illustrating an example of a workshop invitation process. The process of FIG. 18 starts when the user U1 presses the Invite button displayed in the user search result screen 404, for example. Hereinafter, the process of FIG. 18 will be described step by step.

(S41) The interface unit 120 receives a request to display a workshop invitation screen 405 from the terminal apparatus 200. The display request includes information indicating a user to be invited to a workshop. For example, when the user U1 presses the Invite button 404c3 for the user U3 displayed on the user search result screen 404, the display request includes information indicating the user U3.

(S42) The interface unit 120 creates an HTML file for displaying the workshop invitation screen 405 on the terminal apparatus 200. The workshop list display section 405a of the workshop invitation screen 405 displays the names of workshops on the basis of the workshop object table 112 in which the user U1 is registered as an owner. The interface unit 120 sends the created HTML file to the terminal apparatus 200 to display the workshop invitation screen 405 on the Web browser of the terminal apparatus 200. Thereby, the workshop invitation screen 405 is displayed on the terminal apparatus 200. In addition, the interface unit 120 sends the workshop invitation table 114 to the terminal apparatus 200.

Then, the user U1 performs an input operation on the workshop invitation screen 405.

(S43) When the Send button 405c on the workshop invitation screen 405 is pressed, the interface unit 120 receives information indicating that an invitation to the workshop has been made, from the terminal apparatus 200.

(S44) The interface unit 120 creates a workshop invitation table 114, and registers the ID of the user U1 as the Personal ID, the ID of the workshop as the Workshop ID, and the ID of the user U3 as the Destination Personal ID in the workshop invitation table 114. The interface unit 120 registers the mail title and mail body entered on the workshop invitation screen 405 in the workshop invitation table 114. The interface unit 120 registers the workshop invitation table 114 in the storage unit 110, and performs a process of sending an electronic mail based on the content.

In addition, the interface unit 120 creates a workshop participation table 113 having the ID of the user U3 as the Personal ID, and registers the workshop participation table 113 in the storage unit 110. A value of “0” indicating “having been offered an invitation” is registered as the Participation Status of the workshop participation table 113. Then, for example, when the user U3 checks the electronic mail and performs an operation to accept the invitation to the workshop, the value in the Participation Status is updated to “2” indicating “going to participate” in the registered workshop participation table 113.

The following describes the case where a user U5 of the terminal apparatus 200a applies for participation in a workshop.

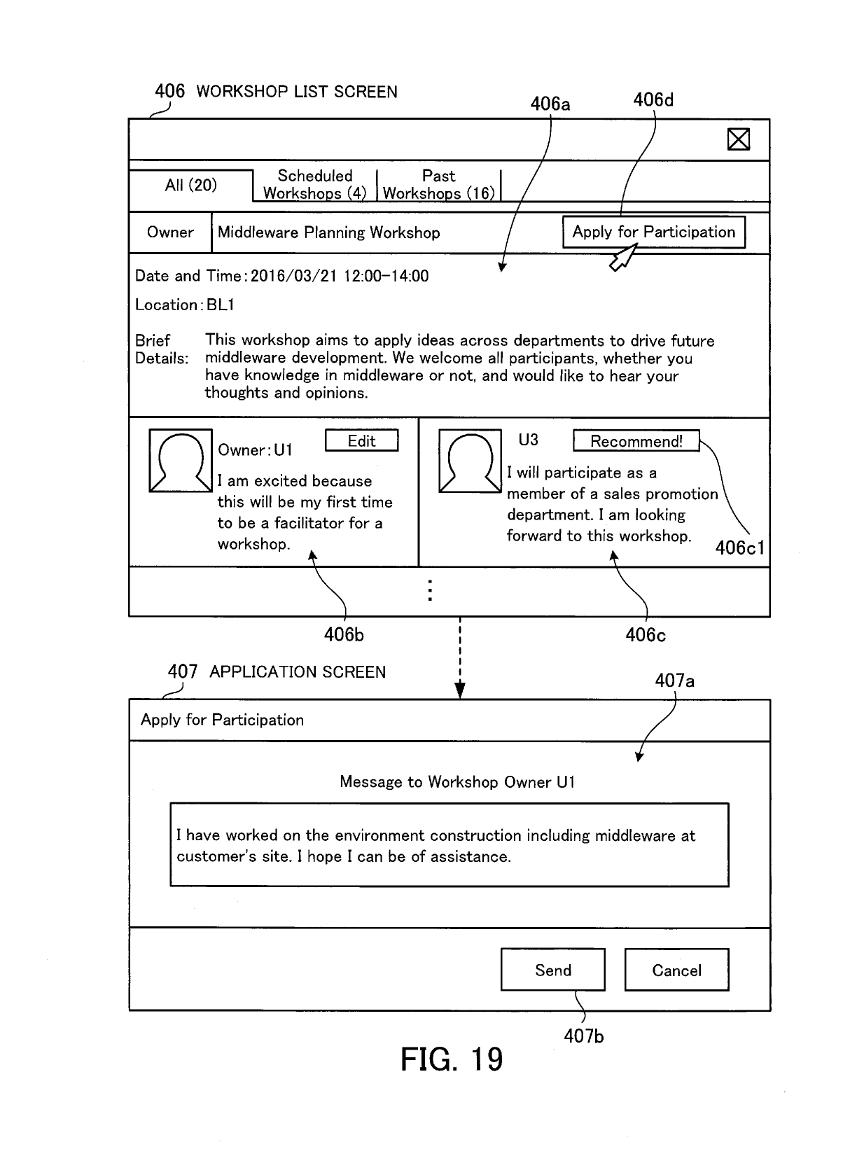

FIG. 19 illustrates an example of a workshop list screen and an application screen. A workshop list screen 406 is a GUI for displaying a list of workshops and information about the workshops.

The user U5 displays the workshop list screen 406 on the terminal apparatus 200a. The workshop list screen 406 lists information about registered workshops. An area corresponding to one workshop includes a workshop information area 406a indicating the details of the workshop, an owner information area 406b indicating information about an owner, and a participant information area 406c indicating information about a participant. The participant information area 406c includes a Recommend button 406c1 for recommending the participant. An area corresponding to the one workshop displays an Apply button 406d. The user U5 specifies a workshop which the user U5 wants to participate in, from the list of workshops displayed on the workshop list screen 406. Then, the user U5 presses the Apply button 406d corresponding to the specified workshop.

When the Apply button 406d is pressed, the application screen 407 is displayed on the terminal apparatus 200a. The application screen 407 is a GUI for entering information about the application. The application screen 407 includes a message entry section 407a for entering information to be given to the owner, such as reasons for the application, and a Send button 407b.

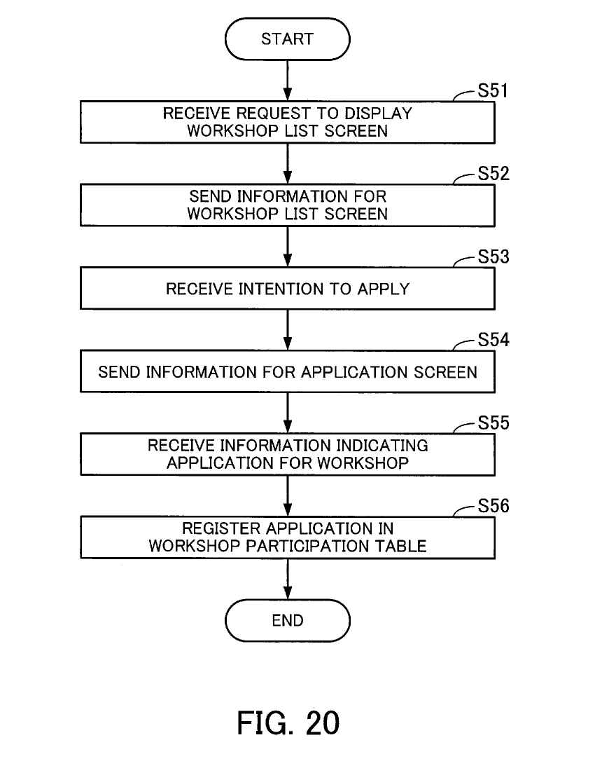

FIG. 20 is a flowchart illustrating an example of an application process. The process of FIG. 20 will be described step by step.

(S51) The interface unit 120 receives a request to display a workshop list screen 406 from the terminal apparatus 200a.

(S52) The interface unit 120 creates a workshop list screen 406 with reference to the workshop object table 112. The workshop information area 406a, owner information area 406b, and participant information area 406c of the workshop list screen 406 display information based on the workshop object table 112 of the workshop, the user table 111 of the owner, and the workshop participation tables 113 of the participants. The interface unit 120 creates an HTML file for displaying the workshop list screen 406 on the terminal apparatus 200a. The interface unit 120 sends the created HTML file to the terminal apparatus 200a to display the workshop list screen 406 on the Web browser of the terminal apparatus 200a. Thereby, the workshop list screen 406 is displayed on the terminal apparatus 200a.

It is assumed that, after that, the user U5 presses the Apply button 406d on the workshop list screen 406. When the Apply button 406d is pressed, the terminal apparatus 200a sends information indicating an intention of the user U5 to apply, to the management server 100.

(S53) The interface unit 120 receives the intention of the user U5 to apply, from the terminal apparatus 200a. At this time, the interface unit 120 is notified of the ID of the sending user.

(S54) The interface unit 120 creates an HTML file for displaying the application screen 407 on the terminal apparatus 200a. The interface unit 120 sends the created HTML file to the terminal apparatus 200a to display the application screen 407 on the Web browser of the terminal apparatus 200a. Thereby, the application screen 407 is displayed on the terminal apparatus 200a.

On the displayed application screen 407, the user U5 enters a message in the message entry section 407a and presses the Send button 407b. When the Send button 407b is pressed, the terminal apparatus 200a sends information indicating the user U5 has applied for the workshop, to the management server 100.

(S55) The interface unit 120 receives the information indicating that the user U5 has applied for the workshop from the terminal apparatus 200a.

(S56) The interface unit 120 creates a workshop participation table 113 having the user U5 registered as the Personal ID, and registers the workshop participation table 113 in the storage unit 110. A value of “1” indicating “having applied for participation” is registered as the Participation Status of the created workshop participation table 113. Then, the process is completed.

The following describes the case where the user U1 who is the owner of a workshop allows an applicant, here, the user U5, to participate in the workshop.

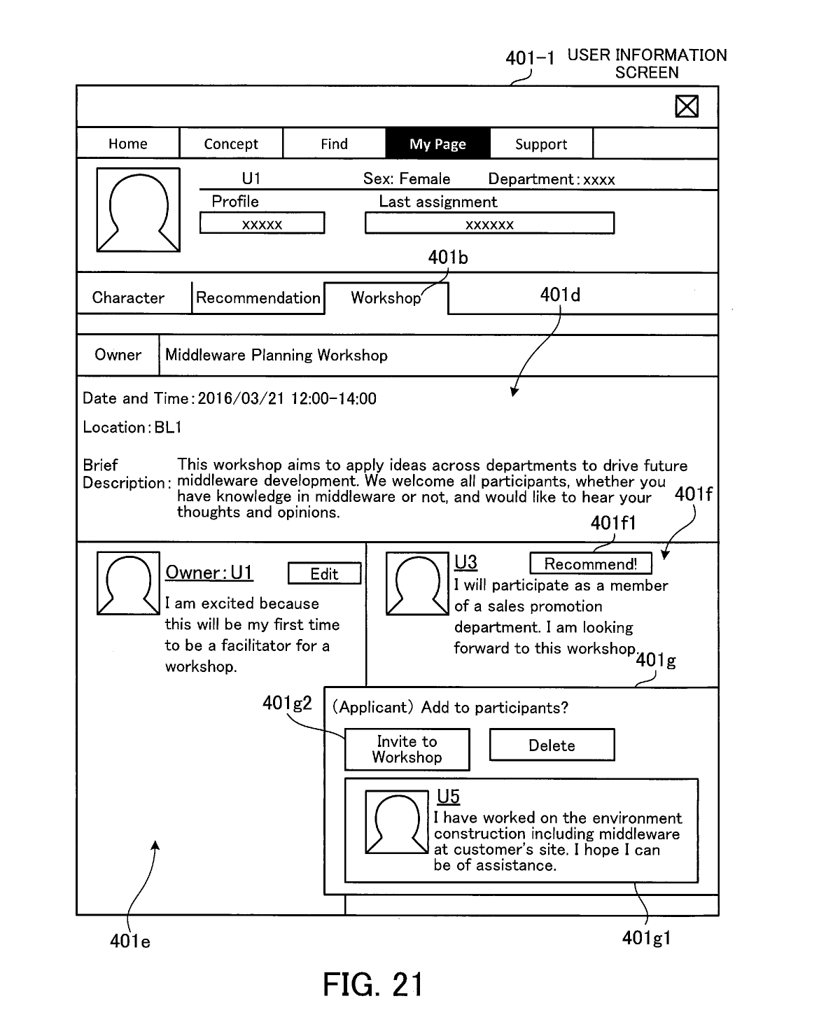

FIG. 21 illustrates an example of a user information screen. A user information screen 401-1 is a GUI for displaying user information. In the case where workshops which the user U1 is going to participate in are registered when the user U1 presses a Workshop tab 401b of the user information screen 401-1, a list of these workshops is displayed. In FIG. 21, information about a workshop whose owner is the user U1 is displayed. The display area for the information about this workshop includes a workshop information area 401d indicating the details of the workshop, the owner information area 401e indicating information about the owner, and a participant information area 401f indicating information about a participant.

In the case where there is a user who has applied for the workshop, an applicant area 401g is displayed. It is assumed in FIG. 21 that the user U5 has applied for the workshop. The applicant area 401g includes an applicant information area 401g1 indicating the name and photo of the user U5 who has applied for the workshop, messages from the applicant, and others, and an Invite button 401g2. By the user U1 pressing the Invite button 401g2, the applicant is accepted as a participant of the workshop.

In addition, by the user U1 pressing the applicant information area 401g1, a user information screen for the user U5 is displayed. The user U1 determines based on the information displayed on the user information screen whether to allow the user U5 to participate in the workshop.

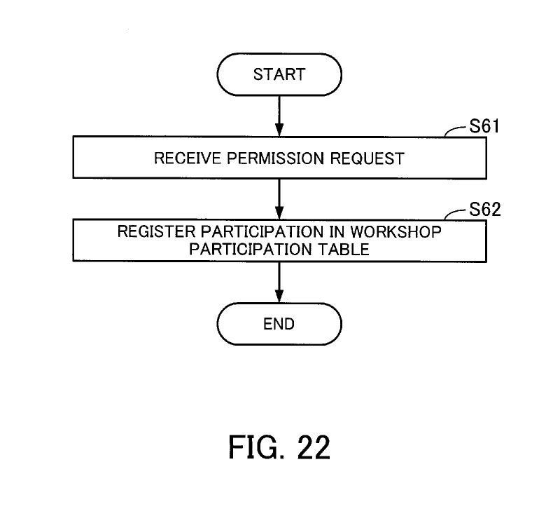

FIG. 22 is a flowchart illustrating an example of a process of allowing participation of an applicant. The process of FIG. 22 starts when the user U1 presses the Invite button 401g2 of the user information screen 401-1. The process of FIG. 22 will be described step by step.

(S61) The interface unit 120 receives a request for permitting the participation of an applicant (user U6) from the terminal apparatus 200.

(S62) The interface unit 120 changes the participation status of the workshop participation table 113 corresponding to the workshop and user U6 from “1” indicating “having applied for participation” to “2” indicating “going to participate”. Then, the process is completed. Note that the interface unit 120 may send an electronic mail indicating the permission of the participation to the user U6.

The following describes the case where a user registers reasons for recommending another user in the management server 100.

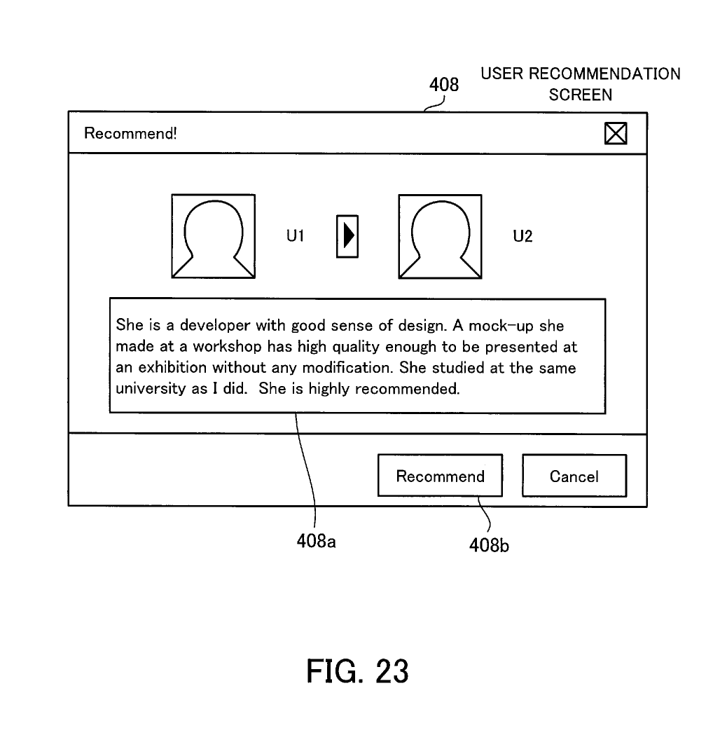

FIG. 23 illustrates an example of a user recommendation screen. A user recommendation screen 408 is a GUI for registering reasons for recommendation.

When a Recommend button is pressed, the user recommendation screen 408 is displayed on the terminal apparatus 200. For example, when a Recommend button (for example, the Recommend button 404c2 of FIG. 15) displayed in a user area of the user search result screen 404, the Recommend button 406c1 (refer to FIG. 19) displayed in the participant information area 406c of the workshop list screen 406, or a Recommend button 401f1 (refer to FIG. 21) displayed in the participant information area 401f of the user information screen 401-1 is pressed, the user recommendation screen 408 is displayed on the terminal apparatus 200.

The user recommendation screen 408 includes an entry area 408a for registering reasons for recommendation in the form of text. In addition, when an execution button 408b of the user recommendation screen 408 is pressed, the registration of the reason for recommendation is requested to the management server 100.

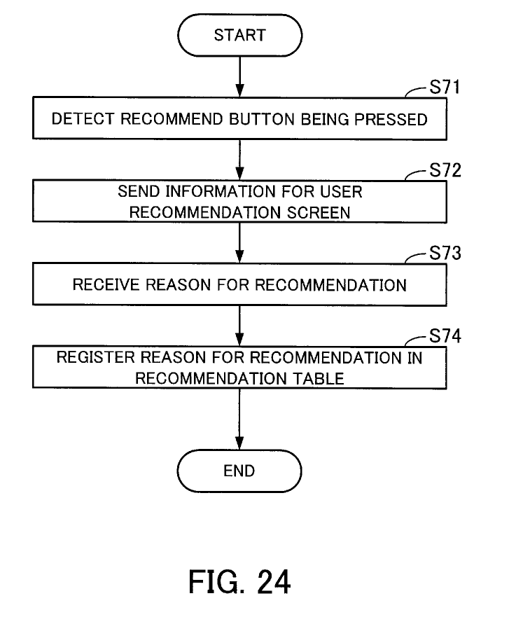

FIG. 24 is a flowchart illustrating an example of a recommendation reason registration process. For example, the process of FIG. 24 starts when the user U1 presses a Recommend button on one of the above-described screens. The process of FIG. 24 will be described step by step.

(S71) The interface unit 120 receives information indicating that a Recommend button has been pressed from the terminal apparatus 200. At this time, the interface unit 120 receives the ID of the recommending user U1 and the ID of the recommended user (here, user U2).

(S72) The interface unit 120 creates an HTML file for displaying the user recommendation screen 408 on the terminal apparatus 200. The interface unit 120 sends the created HTML file to the terminal apparatus 200 to display the user recommendation screen 408 on the Web browser of the terminal apparatus 200. Thereby, the user recommendation screen 408 is displayed on the terminal apparatus 200.

When the user recommendation screen 408 is displayed on the terminal apparatus 200, the user U1 enters reasons for recommending the user U2 in the entry area 408a. When the user U1 presses the execution button 408b on the user recommendation screen 408, the terminal apparatus 200 sends the reasons for recommendation to the management server 100.

(S73) The interface unit 120 receives the reasons for recommendation from the terminal apparatus 200.

(S74) The interface unit 120 creates a recommendation table 115 and registers the ID of the user U1 as the Personal ID, the ID of the user U2 as the Evaluation Subject Personal ID, and the text entered in the entry area 408a as the Reason for Recommendation in the recommendation table 115. The interface unit 120 registers the created recommendation table 115 in the storage unit 110. Then, the process is completed.

The following describes the case where the user U1 who is the owner of a workshop desires to research a potential invitee to the workshop.

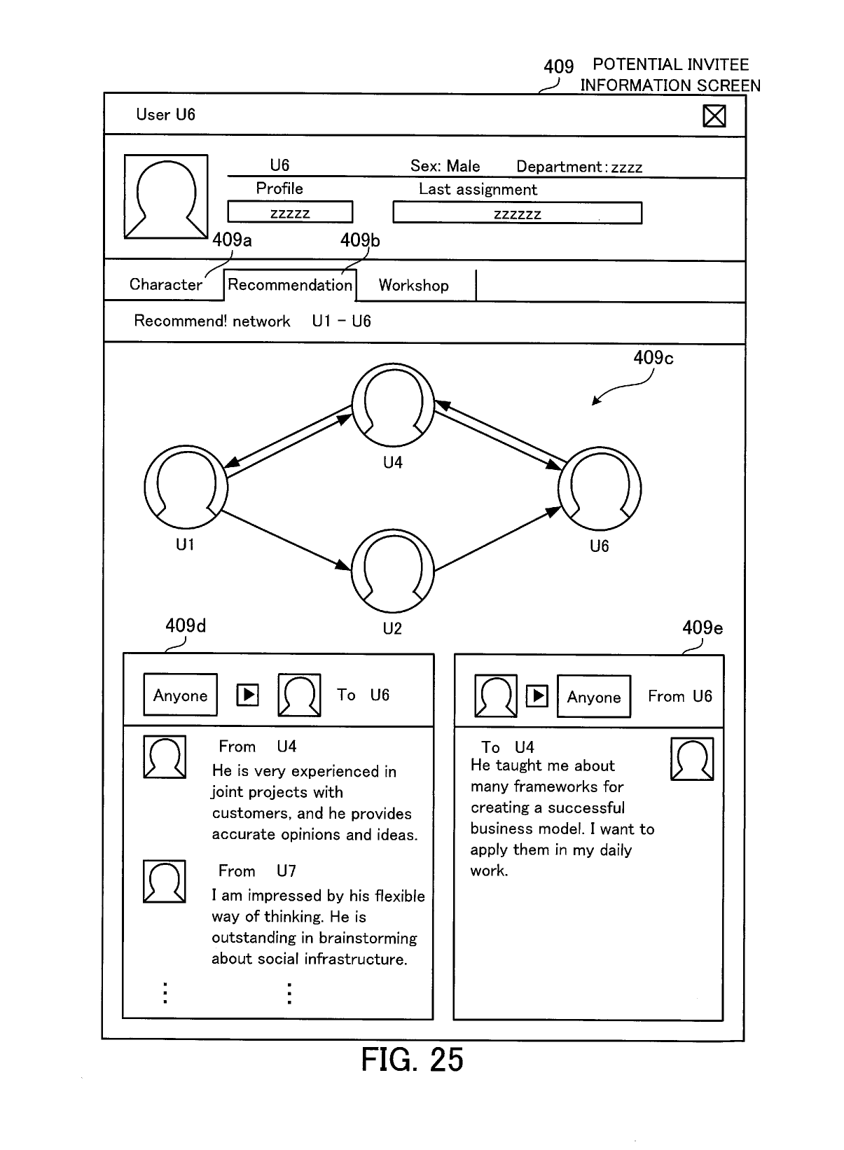

FIG. 25 illustrates an example of a potential invitee information screen. A potential invitee information screen 409 is a GUI for displaying information about a potential invitee.

For example, when the user U1 searches for people who the user U1 will want to invite to a workshop, the user search result screen 404 is displayed to display potential invitees who the user U1 may want to invite to the workshop (refer to FIG. 15). Among the potential invitees, there are some who the user U1 does not know. Therefore, to decide whether to invite such an unacquainted user to the workshop, the user U1 displays the potential invitee information screen 409 including the detailed information about the user on the terminal apparatus 200. More specifically, the user U1 displays the potential invitee information screen 409 on the terminal apparatus 200 by pressing a headshot in the user area (for example, either of the user areas 404b and 404c of FIG. 15) displayed on the user search result screen 404.

Alternatively, the potential invitee information screen 409 may be displayed when information about a user who has applied for a workshop is checked. More specifically, when the user U1 presses an applicant information area 401g1 of the user information screen 401-1 (refer to FIG. 21), the potential invitee information screen 409 is displayed on the terminal apparatus 200.

The potential invitee information screen 409 displays detailed information about a potential invitee. FIG. 25 illustrates the case where detailed information about a user U6 who is a potential invitee is displayed in the potential invitee information screen 409. By pressing a Character tab 409a on the potential invitee information screen 409, the details of information based on the user table 111 of the user U6 are displayed. In addition, by pressing a Recommendation tab 409b, information based on the recommendation table 115 relating to the user U6 is displayed on the potential invitee information screen 409 as illustrated in FIG. 25. At this time, the potential invitee information screen 409 includes a network diagram 409c, a recommender display section 409d, and recommended person display section 409e.

In the network diagram 409c, a recommendation relationship between the user U1 who is an operator and the user U6 who is a potential invitee is represented by arrows in a range of recommendation relationships linked between the user U1 and the user U6. In addition, the direction of an arrow indicates who is a recommender. For example, referring to the example of FIG. 25, the arrows indicate that the user U1 recommends the users U2 and U4, and the users U2 and U4 recommend the user U6. In addition, the user U6 recommends the user U4, and the user U4 recommends the user U1. From such arrows, it is possible to confirm the recommendation relationships between recommenders and recommended people.

Since there are links between the user U1 and the user U6, the user U1 is able to recognize the existence of recommendation relationships between the user U1 and the user U6 via at least a user having a recommendation relationship with the user U1. For example, the user U1 expects that a fewer links between the user U1 and the user U6 in the network diagram 409c indicate that the user U6 is more appropriate as a potential invitee.

In this connection, the network diagram 409c is displayed only when the number of links between the user U1 who is an operator and the user U6 who is a potential invitee does not exceed a prescribed value. Too many links provide a difficulty in confirming recommendation relationships. Therefore, for example, three links at most are desirable (that is, other two users at most are interposed between the user U1 and the user U6).

The recommender display section 409d displays users who recommend the user U6, i.e., a potential invitee and reasons for the recommendation. The recommender display section 409d displays all users who recommend the user U6 and their reasons for the recommendation, irrespective of the link state of the recommendation relationship between the user U1 and the user U6.

The recommended person display section 409e displays users who are recommended by the user U6, who is a potential invitee, and reasons for the recommendation. The recommended person display section 409e displays all users recommended by the user U6 and the reasons for the recommendation, irrespective of the link state of the recommendation relationships from the user U1 to the user U6.

As described above, the recommender display section 409d and recommended person display section 409e display all users who recommend the user U6 and all users who are recommended by the user U6, irrespective of whether these users connect the user U1 and the user U6 or not. The user U1 is able to recognize relationships between users who the user U1 does not know and the user U6 by confirming the names of such users and the reasons for the recommendation. This enables the user U1 to consider whether the user U6 is appropriate as a potential invitee or not, in a viewpoint different from the network diagram 409c. Especially, by confirming not only user names but also reasons for recommendation, the user U1 is able to know about the user U6 more accurately.

In addition, by confirming the network diagram 409c and both the recommender display section 409d and recommended person display section 409e, the user U1 is able to invite appropriate users to a workshop. Furthermore, the efficiency in selecting appropriate users may be improved.

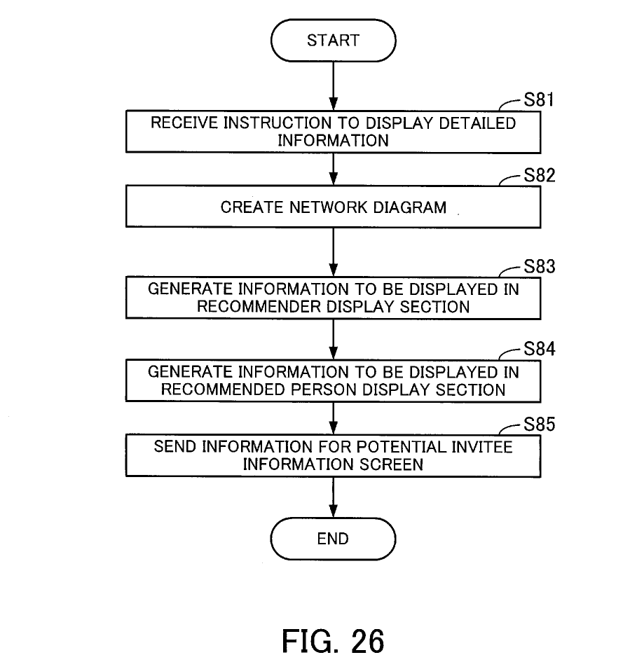

FIG. 26 is a flowchart illustrating an example of a process of displaying a potential invitee information screen. The process of FIG. 26 starts when the user U1 presses a Recommendation tab 409b on the potential invitee information screen 409. The process of FIG. 26 will be described step by step.

(S81) The interface unit 120 receives an instruction to display detailed information about a user (here, referred to as user U6) selected by the user U1 from the terminal apparatus 200.

(S82) The interface unit 120 creates a network diagram 409c between the user U1 and the user U6. More specifically, the interface unit 120 determines the recommendation relationships between the user U1 and the user U6 by tracing the recommendation tables 115 of recommended users starting with the recommendation table 115 indicating either the user U1 or U6 as a recommender (a registered user identified by the Personal ID). If the users are connected via a predetermined number of links or less, the interface unit 120 creates the network diagram 409c on the basis of the determined recommendation relationships.

(S83) The interface unit 120 generates information to be displayed in the recommender display section 409d. More specifically, the interface unit 120 detects all recommendation tables 115 having the ID of the user U6 as the Evaluation Subject Personal ID, and generates the display information on the basis of the detected recommendation tables 115.

(S84) The interface unit 120 generates the information to be displayed in the recommended person display section 409e. More specifically, the interface unit 120 detects all recommendation tables 115 having the ID of the user U6 as the Personal ID, and generates the display information on the basis of the detected recommendation tables 115.

(S85) The interface unit 120 creates an HTML file for displaying the potential invitee information screen 409 including the display information created at step S82 to S84 on the terminal apparatus 200. The interface unit 120 sends the created HTML file to the terminal apparatus 200 to display the potential invitee information screen 409 on the Web browser of the terminal apparatus 200. Thereby, the potential invitee information screen 409 is displayed on the terminal apparatus 200.

The following describes the case of displaying reasons for recommendation.

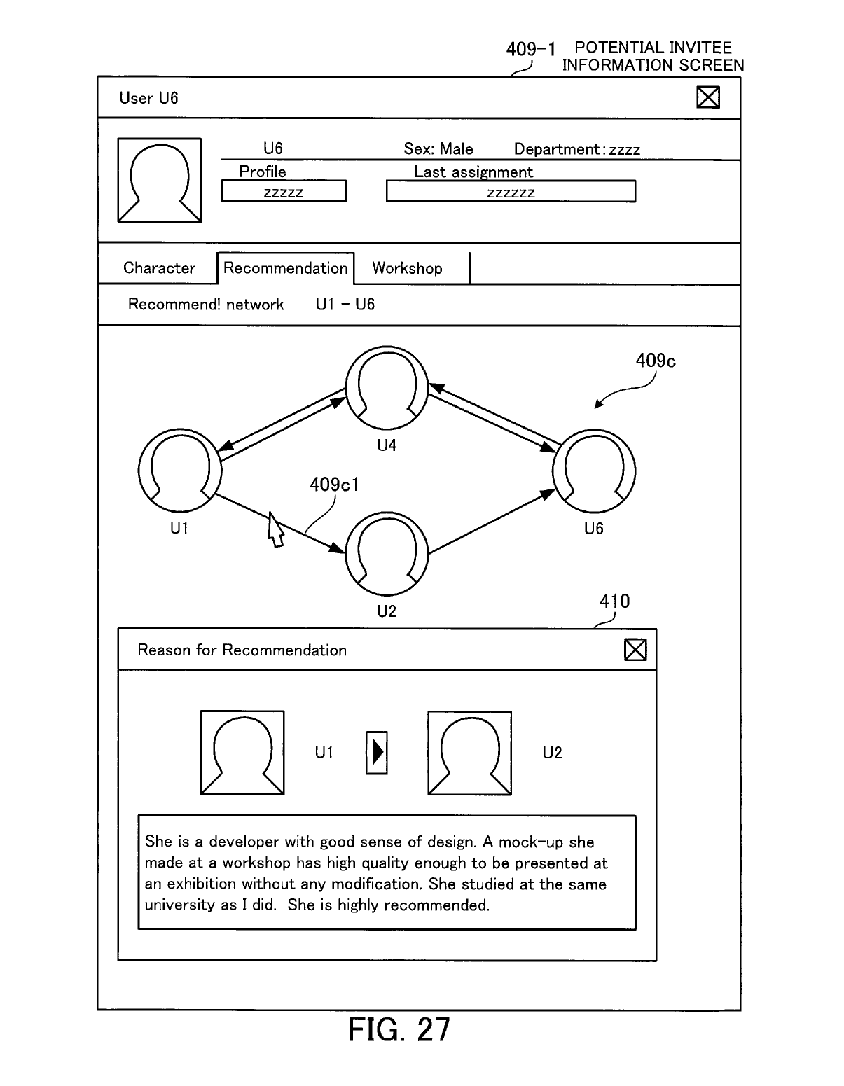

FIG. 27 is a diagram illustrating an example of a recommendation screen. A recommendation screen 410 is a GUI for displaying reasons for recommendation. The recommendation screen 410 is displayed on the terminal apparatus 200 when the user U1 presses an arrow in the network diagram 409c displayed in a potential invitee information screen 409-1. For example, when the user U1 presses an arrow 409c1 indicating a recommendation relationship from the user U1 to the user U2 displayed in the network diagram 409c, the recommendation screen 410 indicating reasons why the user U1 recommends the user U2 pops up on the potential invitee information screen 409-1. In this way, by pressing an arrow, the user U1 is able to know the reasons for the recommendation.

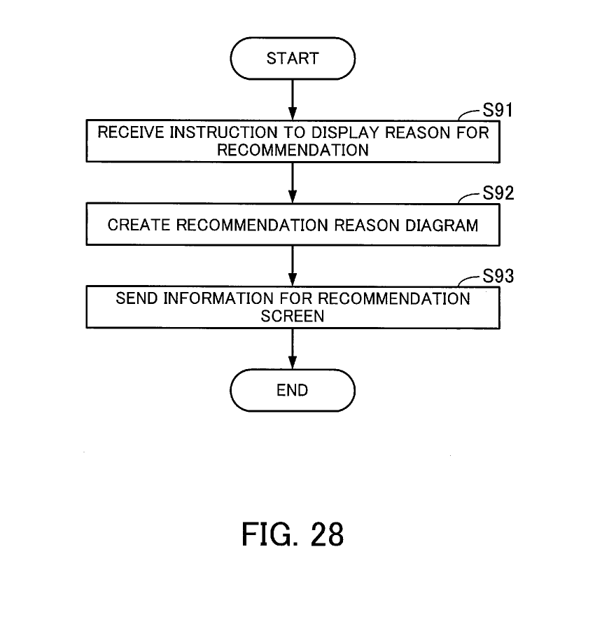

FIG. 28 is a flowchart illustrating an example of a process of displaying a recommendation screen. The process of FIG. 28 starts when the user U1 presses an arrow displayed in the network diagram 409c. In this example, it is assumed that an arrow 409c1 indicating a recommendation relationship from the user U1 to the user U2 has been pressed. Hereinafter, the process of FIG. 28 will be described step by step.

(S91) The interface unit 120 receives an instruction to display reasons for recommendation from the terminal apparatus 200. In addition, the display instruction includes the IDs of the recommender (user U1) and the recommended person (user U2) having the recommendation relationship.

(S92) The interface unit 120 creates a recommendation reason diagram to be displayed on the recommendation screen 410. More specifically, the interface unit 120 detects a recommendation table 115 having the ID of the user U1 as the Personal ID and the ID of the user U2 as the Evaluation Subject Personal ID. The interface unit 120 creates the recommendation reason diagram including recommendation reasons registered in the detected recommendation table 115.

(S93) The interface unit 120 creates an HTML file for displaying the recommendation screen 410 including the diagram created at step S92, on the terminal apparatus 200. The interface unit 120 sends the created HTML file to the terminal apparatus 200 to display the recommendation screen 410 on the Web browser of the terminal apparatus 200. Thereby, the terminal apparatus 200 pops up the recommendation screen 410 on the potential invitee information screen 409.

Note that the information processing of the first embodiment may be implemented by causing a processor used as the computing unit 12 to execute a program. The information processing of the second embodiment may be implemented by causing the processor 101 to execute a program. Such a program may be recorded in a computer-readable recording medium.

For example, recording media on which the program is stored may be put on sale to distribute the program. Alternatively, programs for implementing the functions corresponding to the interface unit 120 and the search unit 130 may be created separately, and then the separate programs may be distributed independently. The functions of the interface unit 120 and the search unit 130 may be implemented by different computers. A computer may load (install) a program from such a recording medium to the RAM 102 or HDD 103 and then reads and executes the program from the storage device.

According to one aspect, it is possible to determine the trustworthiness of a user easily.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory; and
a processor configured to perform a process including
accepting a registration of information indicating a trust relationship between specified users among a plurality of users who are registered,
storing the information in the memory, and
displaying, upon receiving an instruction to display a relationship between a first user and a second user among the plurality of users, a correlation diagram of trust relationships in a range of trust relationships linked between the first user and the second user, and information indicating a trust relationship registered for trust to the second user, irrespective of the range, in parallel to each other.

2. The information processing apparatus according to claim 1, wherein the displaying includes displaying information indicating a trust relationship registered by the second user for trust to another user, as well as the information indicating the trust relationship registered for the trust to the second user, in parallel to each other.

3. The information processing apparatus according to claim 1, wherein, in the correlation diagram, directions of the trust relationships between users included in the range are represented by connection lines connecting the users, the users including the first user and the second user.

4. The information processing apparatus according to claim 3, wherein the process further includes displaying, when one connection line is selected from the connection lines in the correlation diagram, information indicating a trust relationship corresponding to the selected connection line.

5. The information processing apparatus according to claim 1, wherein
the accepting includes accepting a registration of information indicating a recommending user and a recommended user, as the information indicating the trust relationship, and
the displaying includes displaying information indicating a user who recommends the second user, as the information indicating the trust relationship registered for the trust to the second user.

6. The information processing apparatus according to claim 5, wherein
the accepting further includes accepting a registration of a recommendation reason why the recommending user recommends the recommended user, as the information indicating the trust relationship, and
the displaying includes further displaying a recommendation reason for recommending the second user, as the information indicating the trust relationship registered for the trust to the second user.

7. The information processing apparatus according to claim 6, wherein
in the correlation diagram, directions of recommendations between users included in the range are represented by connection lines connecting the users, the users including the first user and the second user, and
the process further includes displaying, when one connection line is selected from the connection lines in the correlation diagram, a recommendation reason for a recommendation between users corresponding to the selected connection line.

8. A correlation display method comprising:
accepting, by a computer, a registration of information indicating a trust relationship between specified users among a plurality of users who are registered; and
displaying, by the computer, upon receiving an instruction to display a relationship between a first user and a second user among the plurality of users, a correlation diagram of trust relationships in a range of trust relationships linked between the first user and the second user, and information indicating a trust relationship registered for trust to the second user, irrespective of the range, in parallel to each other.

9. A non-transitory computer-readable recording medium storing a correlation display program that causes a computer to perform a process comprising:
accepting a registration of information indicating a trust relationship between specified users among a plurality of users who are registered; and
displaying, upon receiving an instruction to display a relationship between a first user and a second user among the plurality of users, a correlation diagram of trust relationships in a range of trust relationships linked between the first user and the second user, and information indicating a trust relationship registered for trust to the second user, irrespective of the range, in parallel to each other.
